(19) United States
(12) Patent Application Publication
(10) Pub. No.: US 2026/0311288 A1
(43) Pub. Date: Oct. 8, 2026

(54) ADAPTATION OF CINEMATIC TO EXPERIENTIAL MEDIA VIA MACHINE LEARNING

(71) Applicant: SPHERE ENTERTAINMENT GROUP, LLC, New York, NY (US)

(72) Inventors: Benjamin GROSSMANN, Los Angeles, CA (US); David Littlefield GROSSMAN, Temecula, CA (US); Kevin Gregory SCHUTZ-MULLICAN, Los Angeles, CA (US)

(73) Assignee: SPHERE ENTERTAINMENT GROUP, LLC, New York, NY (US)

(21) Appl. No.: 19/428,664

(22) Filed: Dec. 22, 2025

Related U.S. Application Data
(60) Provisional application No. 63/784,722, filed on Apr. 7, 2025.

(51) Int. Cl. G06T 3/08; G06T 3/4053; G06V 10/778; G06V 20/40; G11B 27/031

(52) U.S. Cl. CPC G06T 3/08; G06T 3/4053; G06V 10/778; G06V 20/41; G06V 20/49; G11B 27/031

(57) ABSTRACT

Disclosed herein are system, method, and computer program product aspects for an experiential media adaptation platform. An embodiment operates by leveraging artificial intelligence and guided generation to adapt cinematic media, for example, rectilinear content, into experiential media, for example, spherical content. An embodiment operates by providing functionality for generating inferred object content. An embodiment also operates by providing functionality for generating guidance images. An embodiment also operates by providing functionality for generating one or more temporal extension videos. An embodiment further operates by providing functionality for upscaling an experiential media. As such, the experiential media adaptation platform may provide more efficient and faithful adaptations compared to conventional systems.

### CROSS-REFERENCE TO RELATED APPLICATIONS

The present application claims the benefit of U.S. Provisional Patent Application No. 63/784,722, filed Apr. 7, 2025, the contents of which is incorporated herein by reference in its entirety.

### BACKGROUND

The United States Media and Entertainment Industry is the largest in the world. The United States Media and Entertainment Industry represents a third of the global media and entertainment industry which delivers events, such as musical events, theatrical events, sporting events, and/or motion picture events, to audiences seated within venues for their viewing pleasure. Often times, an event combines many different graphical elements, such as images and/or videos to provide some examples, to enhance the immersion of the audience as they are viewing the event. However, media is conventionally predominantly created and optimized for rectilinear display formats with standardized aspect ratios, commonly offering fields of view ranging from 15 to 90 degrees. However, these conventional formats face significant technical challenges when attempting to present the same content on non-conventional media planes.

### BRIEF DESCRIPTION OF THE DRAWINGS

FIG. 1 illustrates an example media plane display environment, according to some embodiments.

FIG. 2A and FIG. 2B illustrate example media plane display environments, according to some embodiments.

FIG. 3A and FIG. 3B illustrate example media plane display environments, according to some embodiments.

FIG. 4 illustrates an example experiential media adaptation system, according to some embodiments.

FIG. 5 illustrates an example media plane display environment, according to some embodiments.

FIG. 6 illustrates another example experiential media adaptation system, according to some embodiments.

FIG. 7 illustrates an example block diagram of an experiential media adaptation platform architecture, according to some embodiments.

FIG. 8 illustrates an example training pipeline for object models, according to some embodiments.

FIG. 9 illustrates an example inference pipeline for generating output image frames, according to some embodiments.

FIG. 10 illustrates an exemplary operational control flow for adapting cinematic media content to experiential media content, according to some embodiments.

FIG. 11 illustrates an exemplary operational control flow for generating inferred object content, according to some embodiments.

FIG. 12 illustrates an exemplary operational control flow for generating a guidance image, according to some embodiments.

FIG. 13 illustrates another exemplary operational control flow for generating a guidance image, according to some embodiments.

FIG. 14 illustrates an exemplary operational control flow for generating one or more temporal extension videos, according to some embodiments.

FIG. 15 illustrates another exemplary operational control flow for generating one or more temporal extension videos, according to some embodiments.

FIG. 16 illustrates an exemplary operational control flow for upscaling an experiential media, according to some embodiments.

FIG. 17 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

The following disclosure provides many different embodiments, or examples, for implementing different features of the provided subject matter. Specific examples of components and arrangements are described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not in itself dictate a relationship between the various embodiments and/or configurations discussed. It is noted that, in accordance with the standard practice in the industry, features are not drawn to scale. In fact, the dimensions of the features may be arbitrarily increased or reduced for clarity of discussion. The following disclosure may include the terms “about” or “substantially” to indicate the value of a given quantity can vary based on a particular technology. Based on the technology, the term “about” or “substantially” can indicate a value of a given quantity that varies within, for example, 1–15% of the value (e.g., ±1%, ±2%, ±5%, ±10%, or ±15% of the value).

### OVERVIEW

Disclosed herein are systems, apparatuses, devices, methods and/or computer program products that adapt cinematic content, for example, rectilinear content, into experiential content, for example, spherical content, for presentation on a non-rectilinear media plane. These systems, apparatuses, devices, methods, and/or computer program products can train machine learning models on objects in a piece of cinematic content (e.g., a character). These systems, apparatuses, devices, methods, and/or computer program products can then use these trained machine learning models to generate content that was not originally contained inside the cinematic content, such as image and/or video content. These systems, apparatuses, devices, methods, and/or computer program products can then adjust the amount of content that should be generated, so that the final piece of media matches the size of a media plane of a venue. These systems, apparatuses, devices, methods, and/or computer program products can then arrange and/or compose the generated content to produce an experiential version of the cinematic content.

Generally, cinematic content refers to media that captures a narrow field of view that is often mapped onto a two-dimensional plane and experiential content refers to media that captures a wide field of view, for example, a 360-degree field of view, that can be mapped onto a three-dimensional media plane. Herein, the term “media” may include, but is not limited to, images, videos, projections, and the like, as well as one or more portions, sections, or subsections thereof. As a convenience and not a limitation, the present disclosure may be described using the terms “media,” “media content,” or “content.” However, one of ordinary skill in the art will appreciate that the terms “media,” “media content,” “content,” “pieces of media,” “pieces of media content,” or “pieces of content” may refer to any type of multimodal content, such as those described above. These systems, apparatuses, devices, methods, and/or computer program products may be used to efficiently adapt cinematic media content to experiential media content. These systems, apparatuses, devices, methods and/or computer program products can leverage artificial intelligence (e.g., guided diffusion) to adapt the two-dimensional image content and/or video content onto the three-dimensional media plane. These systems, apparatuses, devices, methods and/or computer program products can provide functionality for generating inferred object content. These systems, apparatuses, devices, methods and/or computer program products can provide functionality for generating guidance images. These systems, apparatuses, devices, methods and/or computer program products can provide functionality for generating one or more temporal extension videos. These systems, apparatuses, devices, methods and/or computer program products can provide functionality for upscaling an experiential media. As such, the experiential media adaptation platform may can provide more efficient and faithful adaptations compared to conventional systems.

### PRIOR ATTEMPTS AT ADAPTING TWO-DIMENSIONAL CONTENT INTO THREE-DIMENSIONAL CONTENT

Before describing these systems, apparatuses, devices, methods and/or computer program products, some conventional attempts to adapt rectilinear media to spherical media are to be generally described. As described in the Background, conventional media is predominantly created and optimized for conventional rectilinear display formats with standardized aspect ratios, offering fields of view ranging from 15 to 90 degrees.

However, these conventional display formats face significant technical challenges when attempting to present the same content on non-conventional media planes, such as spherical or experiential displays that encompass wider fields of view (e.g., 180 degrees), operate at higher resolutions, and/or are mapped spherically around the audience in a three-dimensional fashion. Other types of non-conventional media planes may include a perceptual two-dimensional screen that uses other techniques to appear three-dimensional. As one example, a venue may have a flat, two-dimensional media plane with a limited field of view. As another example, a virtual reality headset may have a flat, two-dimensional media plane that employs head tracking technology, which can create a perceived three-dimensional environment by adjusting the content on the media plane as users turns their heads.

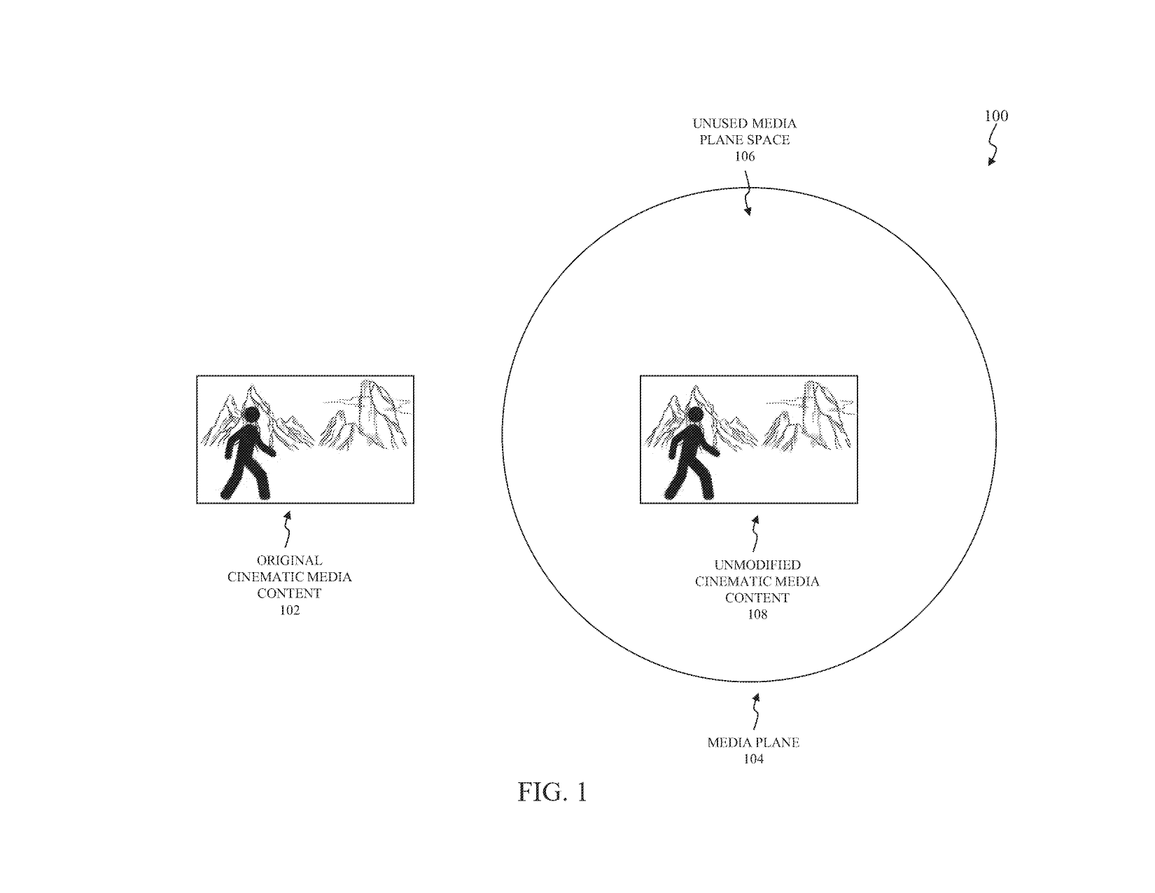

Some conventional approaches aim to preserve cinematic details and composition by displaying and/or projecting the rectilinear media in its original aspect ratio and resolution (e.g., without alterations) in a media plane. However, displaying the original rectilinear media with no modifications can create technical inefficiencies in unused, wasted space in the media plane. FIG. 1 illustrates an example of such an approach. FIG. 1 illustrates an example media plane display environment 100, which includes an original cinematic media content 102 being displayed as an unmodified cinematic media content 108 on a media plane 104. Unmodified cinematic media content 108 may be the same or about the same resolution as original cinematic media content 102. It should be noted that the shape of media plane 104 as illustrated in FIG. 1 is for illustrative purposes only and should not be considered limiting. Generally, media plane 104 refers to one or more surfaces or structures within a venue that serve as platforms for projecting or displaying media. The venue can represent a music venue, for example, a music theater, a music club, and/or a concert hall, a sporting venue, for example, an arena, a convention center, and/or a stadium, and/or any other suitable venue that will be apparent to those skilled in the relevant art(s) without departing the spirit and scope of the present disclosure. In some embodiments, media plane 104 can be spread across the interior of the venue to create an immersive visual experience. In these embodiments, media plane 104 can be configured as a three-dimensional media plane that is spread across the interior of the venue. For example, media plane 104 may include a 19,000 by 13,500 LED visual display wrapping around the interior of a spherical structure, a spherical-like structure, a hemispherical

structure, also referred to as a hemispherical dome, or a hemispherical-like structure, among others. Alternatively or additionally, media plane 104 may be part of a virtual environment, for example, a virtual reality (VR) environment, an augmented reality (AR) environment, and the like.

Media plane 104 may be in a different format than and/or be in a resolution that is larger or smaller than original cinematic media content 102 and unmodified cinematic media content 108. As depicted in FIG. 1, displaying and/or projecting unmodified cinematic media content 108 on media plane 104 may result in unused media plane space 106. Unused media plane space 106 may be filled with null or black pixels, which can decrease the visual impact of the content as these null or black pixels reduce the overall appeal and immersion of the viewing experience. Additionally, unused media plane space 106 results in inefficient use of hardware, such as projectors or LED panels, which are not being fully utilized, leading to both performance and energy inefficiencies. The rendering process for unused media plane space 106 can also reduce the frame rate or cause lag as more computational resources are spent on rendering null or black pixels. This can introduce latency, especially in live or real-time applications, and create delays in content delivery. As used herein, “content delivery” may refer to the transmission and provision of encoded media content to a recipient device or structure for playback or viewing. Furthermore, unused media plane space 106 can cause inconsistent content presentation, disrupting smooth transitions in dynamic or interactive environments. Finally, storing and processing media with large null regions of null or black pixels can strain memory and storage resources leading to higher costs and more complex data management.

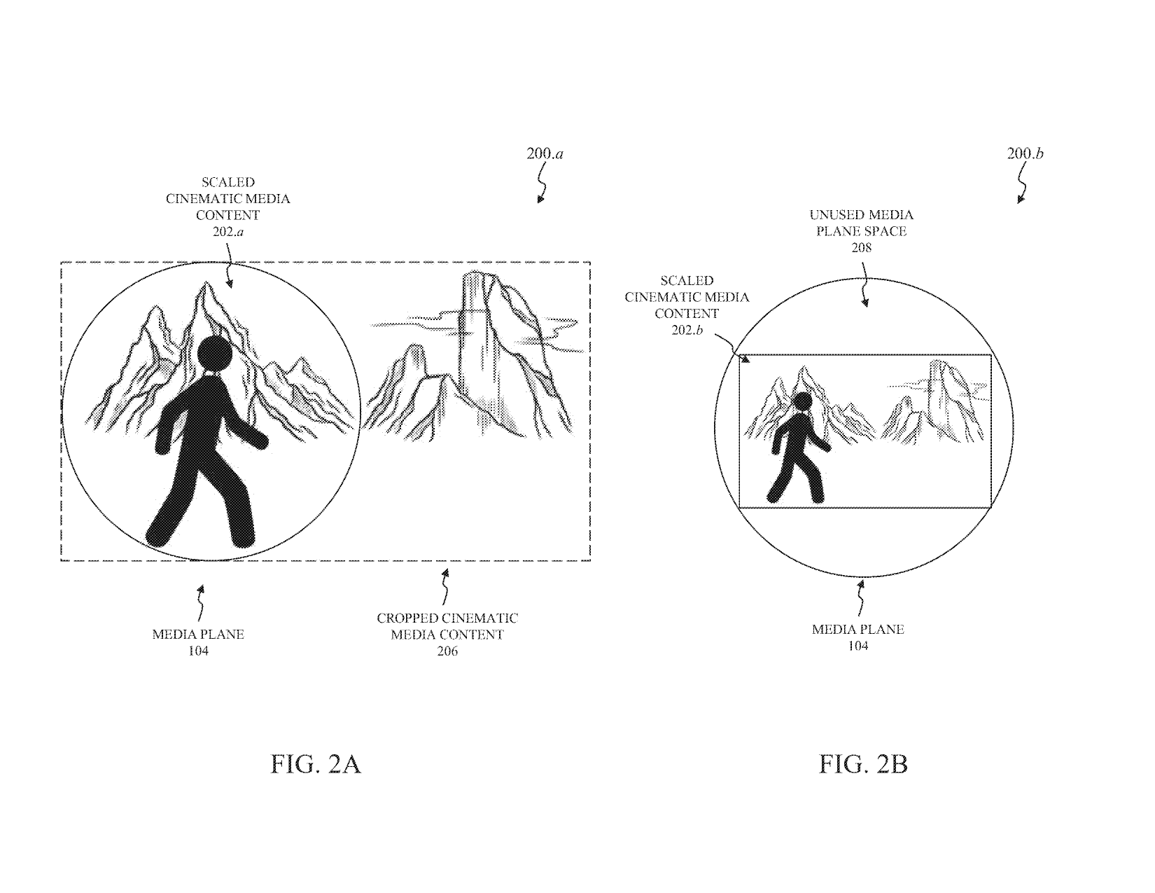

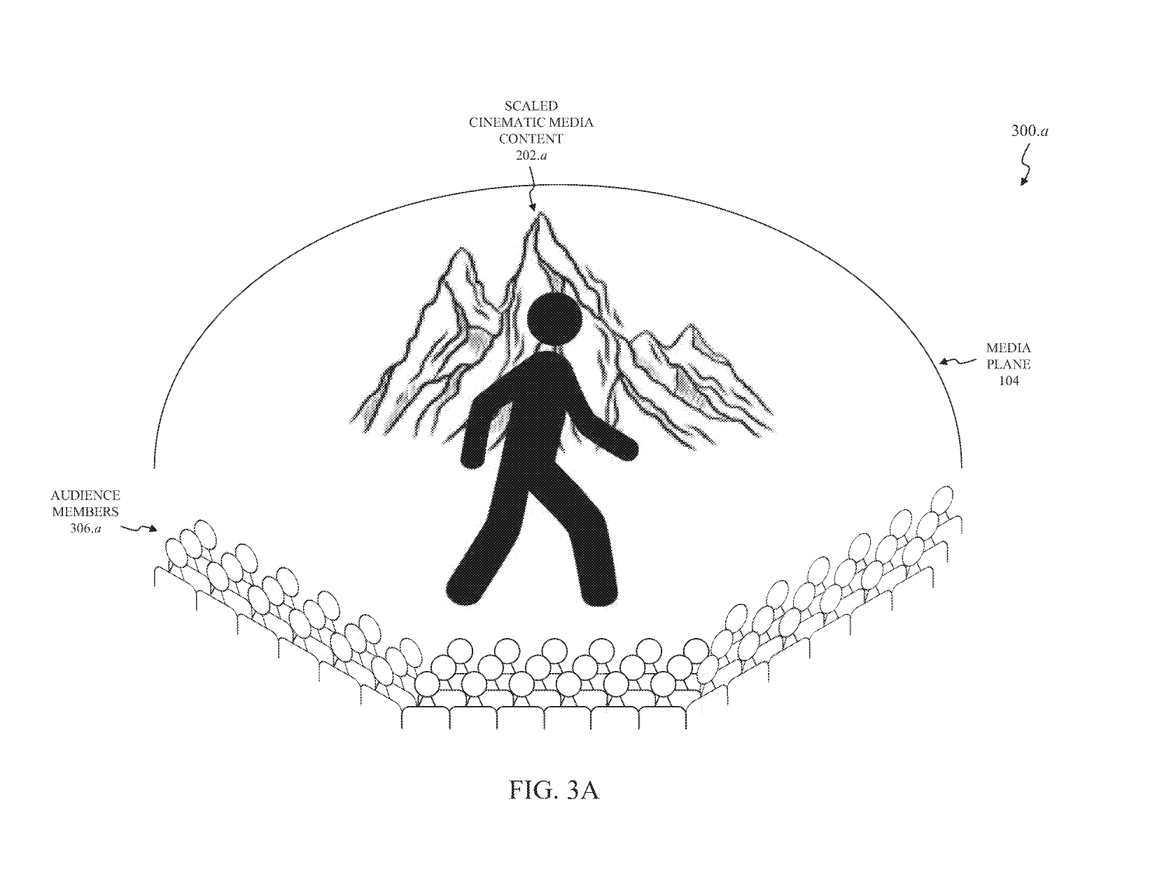

Some conventional approaches attempt to address these inefficiencies by scaling and/or cropping the rectilinear media to fit media plane 104. However, these conventional approaches also face fundamental technical limitations. When scaling and/or cropping the rectilinear content to fill the media plane 104, critical pixel information may be lost. FIG. 2A illustrates an example of such an approach. FIG. 2A illustrates an example media plane display environment 200.a. As illustrated in FIG. 2A, original cinematic media content 102 can be scaled, for example, stretched, to fill media plane 104 to provide a scaled cinematic media content 202.a. Additionally, scaled cinematic media content 202.a can be cropped to fit within the boundaries of media plane 104 which results in cropped cinematic media content 206 extending beyond the boundaries of media plane 104. Any pixel information contained within cropped cinematic media content 206 may be lost during content delivery.

When cropping original cinematic media content 102 to fit media plane 104 instead (e.g., letterboxing), the same technical issues described above with respect to inefficient display utilization are perpetuated. FIG. 2B illustrates an example of such an approach. FIG. 2B illustrates an example media plane display environment 200.b. As illustrated in FIG. 2B, original cinematic media content 102 can be scaled, for example, stretched, to fit media plane 104 to provide a scaled cinematic media content 202.b.Similar to FIG. 1, media plane display environment 200.b may result in an unused media plane space 208 that can result in similar technical challenges as described herein.

Further technical challenges relating to disparities between the resolution of original cinematic media content 102 and the resolution of media plane 104 are faced by these systems. Media plane 104, for example, spherical and/or experiential displays, often operates at higher resolutions than conventional displays for displaying original cinematic media content 102. At times, the difference can be substantial. However, conventional systems and methods for scaling original cinematic media content 102 often cause visual artifacts such as blurring, pixilation, or abnormal/non-uniform sharpening. These artifacts are particularly problematic when viewed from closer distances, where viewers can more easily detect imperfections that might be imperceptible at further distances.

Beyond the technical challenges with displaying the adapted content described above, additional technical challenges lie in maintaining data fidelity (both to original cinematic media content 102 and to media plane 104). As used herein, “data fidelity” may refer the degree to which the stored information accurately represents its intended purpose. Conventional cinematic content, for example, original cinematic media content 102, is typically engineered in a specific, technical way for directed attention within a limited frame, using composition, lighting, and focus techniques that assume a fixed perspective. However, when original cinematic media content 102 is presented on media plane 104, these technical elements become ineffective or even contradictory, resulting in lowered data fidelity with respect to the original cinematic media content 102. Some conventional approaches attempt to address this by employing computer vision-based conversion processes. These approaches leverage various algorithms to recompose content for spherical or experiential viewing, such as but not limited to, scene reconstruction, object detection and boundary identification, three-dimensional geometry processing, and texture mapping, oftentimes over countless iterations to obtain the final result. These expensive series of operations, however, similarly lead to high resource utilization and processing overhead. Furthermore, additional technical challenges arise in understanding scene semantics, identifying focal points, and predicting viewer patterns across media plane 104.

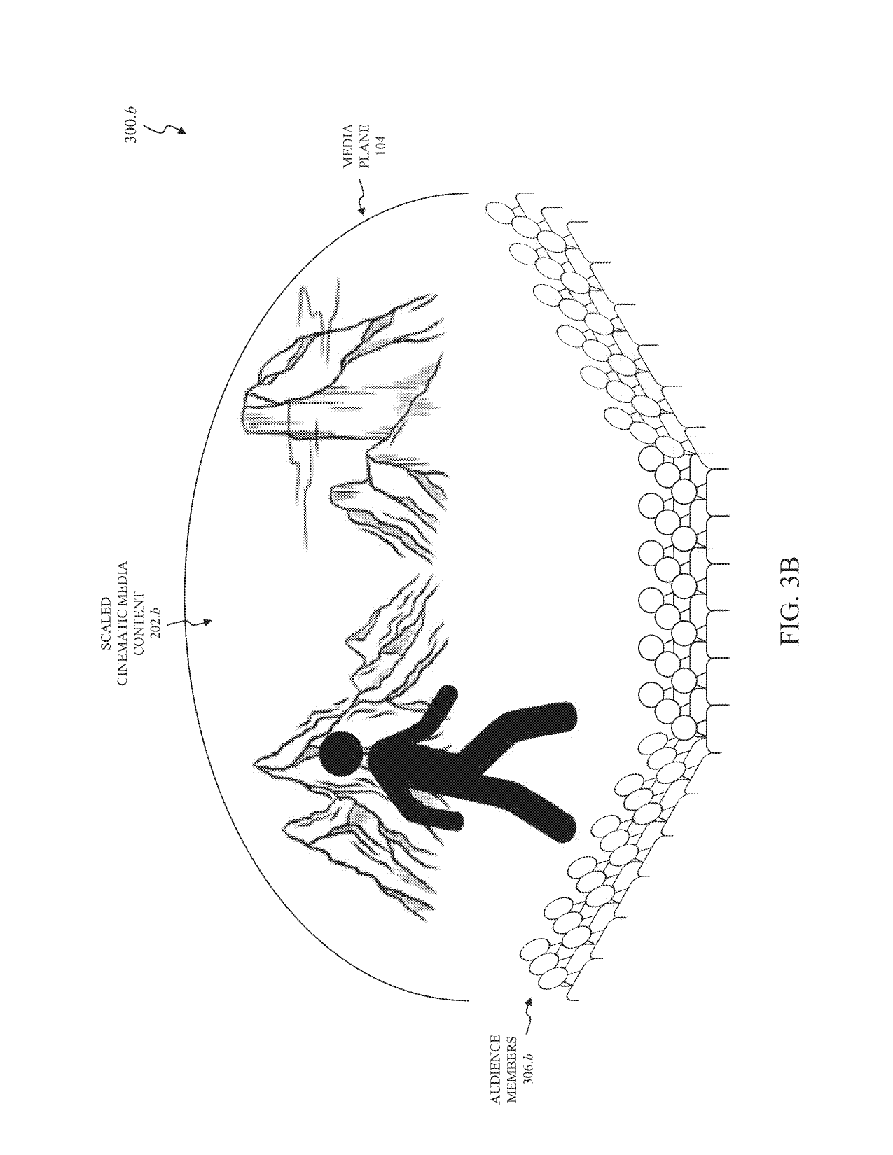

The various conventional approaches described above also face data fidelity challenges with respect to media plane 104. Because original cinematic media content 102 was designed for passive viewing, adaptations for environments designed for immersion and agency produced via conventional approaches cause perceptual dissonance. This dissonance manifests as measurable inconsistencies between the displayed visual information and the visual information that is received or expected. As a result, the final data output is lacking in coherence and fidelity. FIGS. 3A and 3B illustrate examples of such conventional approaches. FIG. 3A illustrates an example media plane display environment 300.a, which includes scaled cinematic media content 202.a scaled to fill media plane 104. Media plane display environment 300.a may also include audience members 306.a that are viewing media plane 104. In some embodiments, scaled cinematic media content 202.a may be measurably inconsistent with an expected display size (e.g., objects depicted by experiential media content 202.a are orders of magnitude larger or smaller than their real-world counterparts). For example, a person depicted by scaled cinematic media content 202.a may be orders of magnitude larger than one or more of audience members 306.a. As a result, scaled cinematic media content 202.a may possess low data fidelity and cause perceptive dissonance in audience members 306.a.

FIG. 3B illustrates another example media plane display environment 300.b, which similarly includes a scaled cinematic media content 202.b scaled to fit media plane 104. Media plane display environment 300.b may similarly include audience members 306.b that are viewing media plane 104. In some embodiments, scaled cinematic media content 202.b may similarly be measurably inconsistent with an expected display size (e.g., subjects depicted by experiential media content 202.b are larger or smaller than their real-world counterparts). For example, a person depicted by scaled cinematic media content 202.b may be larger than one or more of audience members 306.b. As a result, scaled cinematic media content 202.b may also possess low data fidelity and cause perceptive dissonance in audience members 306.b.

### EXEMPLARY EXPERIENTIAL MEDIA ADAPTATION PLATFORM

Aspects of the disclosure herein solve these technological problems by implementing an experiential media adaptation platform, which may provide functionality for adapting cinematic content, for example, rectilinear content, into experiential content, for example, spherical content, for presentation on media plane 104. In some embodiments, the experiential media adaptation platform may train one or more machine learning models on one or more objects of cinematic media content. These machine learning models can be used to generate inferred content of the one or more objects within one or more frames of the cinematic media content to produce one or more expanded frames. As used herein, “inferred content” may refer to any content that is generated based on one or more contextual and/or conditioning signals. These machine learning models can also temporally extend the one or more expanded frames to produce one or more temporal extension videos. The experiential media adaptation platform may then compose the one or more temporal extension videos to produce an experiential version of the cinematic media content. The experiential media adaptation platform may also align the resolutions of the one or more temporal extension videos with the resolution of media plane 104.

To generate inferred object content, the experiential media adaptation platform may annotate one or more frames of a cinematic media content, in some embodiments. Each frame may include the one or more objects for the annotation. The experiential media adaptation platform may train the one or more machine learning models using the annotated frames. The experiential media adaptation platform may obtain one or more guidance images that outline content to add to the one or more frames of the cinematic media content. In some embodiments, the amount of content to be added may be based on a resolution of media plane 104. The experiential media adaptation platform may then define one or more parameters for one or more trained machine learning models and one or more queries for these trained machine learning models that describe one or more targets output for one or more expanded frames. The experiential media adaptation platform may then generate the inferred content of the one or more objects in the frame using the one or more trained machine learning models and the guidance image. Alternatively or additionally, the experiential media adaptation platform may perform segmentation on the cinematic media content to identify the target object and obtain the one or more frames to annotate.

In some embodiments, the experiential media adaptation platform may generate one or more guidance images using one or more modeling engines. The experiential media adaptation platform may scale the one or more frames of the cinematic media content to meet an immersion threshold, in some embodiments. The immersion threshold may be for one or more frames of an experiential version of the cinematic media content. The experiential media adaptation platform may then insert the one or more scaled frames into one or more frames of the experiential version of the cinematic media content. In some embodiments, the one or more frames of the experiential version of the cinematic media content may be one or more placeholder or incomplete frames, on which the experiential media adaptation platform may perform processing. The experiential media adaptation platform may also generate one or more scenes from the cinematic media content via the one or more modeling engines. These scene may depict one or more target outputs for expanding the one or more scaled frames. The experiential media adaptation platform may also align the one or more scaled frames with the one or more generated scenes. The experiential media adaptation platform may then capture the one or more generated scenes along with the one or more scaled frames to obtain the one or more guidance images.

Alternatively or additionally, the one or more modeling engines may capture the one or more generated scenes and transmit them to the experiential media adaptation platform. In some embodiments, the one or more guidance images may be one or more previsualization shots of the experiential version of the cinematic media content and/or be in a lower resolution than the scaled frame. Alternatively or additionally, the experiential media adaptation platform may generate the one or more guidance images using the one or more machine learning models. The experiential media adaptation platform may define one or more parameters for the one or more machine learning models and one or more queries describing a target output for the one or more guidance images. The experiential media adaptation platform may then transmit the query to the one or more machine learning models and receive the one or more generated guidance images.

To produce one or more temporal extension videos, the experiential media adaptation platform may obtain one or more key frames for the experiential version of the cinematic media content, in some embodiments. In some embodiments, the experiential media adaptation platform may perform segmentation on the cinematic media content to obtain one or more image segments that include the one or more objects of the cinematic media content. The experiential media adaptation platform may then estimate one or more poses of the one or more objects in the one or more image segments to obtain one or more pose keypoints. The experiential media adaptation platform may generate one or more control maps from the one or more pose keypoints. The experiential media adaptation platform may then generate the one or more key frames using the one or more machine learning models and the one or more control maps.

In some embodiments, the experiential media adaptation platform may then define one or more parameters of the one or more machine learning models and one or more queries describing one or more target outputs for one or more interpolated frames between two key frames. In some embodiments, the experiential media adaptation platform may define different parameters and/or queries for one or more interpolated frames between different key frames. Alternatively or additionally, the experiential media adaptation platform may leverage the same parameters and/or queries for all the interpolated frames between all the key frames. The experiential media adaptation platform may then generate the one or more interpolated frames between key frames. The experiential media adaptation platform may also define one or more additional parameters of the one or more machine learning models and one or more additional queries for one or more subsequent frames after the one or more key frames. The experiential media adaptation platform may then generate the one or more subsequent frames using the one or more machine learning models to produce the one or more temporal extension videos. In some embodiments, the experiential media adaptation platform may perform frame rate up-conversion on the one or more temporal extension videos.

In some embodiments, the experiential media adaptation platform may upscale the one or more temporal extension videos, for example, to align the one or more temporal extension videos with a resolution of media plane 104 and/or to achieve a threshold level of immersion. The experiential media adaptation platform may define one or more parameters for the one or more machine learning models and one or more queries describing one or more target outputs for the one or more temporal extension videos. The experiential media adaptation platform may then upscale one or more frames of the one or more temporal extension videos to align the resolution of the one or more temporal extension videos with a resolution of media plane 104. The experiential media adaptation platform may then refine the one or more upscaled frames of the one or more temporal extension videos until a pre-defined temporal coherence threshold across the one or more upscaled frames is met. In some embodiments, the experiential media adaptation platform may optimize against frame difference-based temporal loss and/or leverage optical flow maps between adjacent frames to guide the refining process. Alternatively or additionally, the experiential media adaptation platform may further refine the one or more temporal extension videos to align with an immersion threshold for the venue.

To upscale one or more frames of the one or more temporal extension videos, the experiential media adaptation platform may split the one or more frames into multiple tiles, in some embodiments. The experiential media adaptation platform may then upscale each tile using the same or a different machine learning model to align the resolution of the final frame with the resolution of media plane 104. The experiential media adaptation platform may blend one or more boundary regions between the tiles using the same or a different machine learning model. The experiential media adaptation platform may then aggregate the tiles to obtain one or more upscaled frames.

These approaches provide direct technological improvements over conventional systems via an implementation that leverages artificial intelligence and guided generation to address the various technical considerations that come with adapting cinematic content into experiential content for presentation on media plane 104. These approaches allow for more efficient and effective creation of experiential content as compared to conventional approaches. These approaches also provide a high fidelity solution with respect to the original technical design and direction of the cinematic content as well as the experiential and/or spherical media plane. As a result, the final displayed visual information may be consistent with the received and/or expected visual information, leading to increased data coherence and fidelity.

The techniques described herein also improve the functioning of a computing system. Leveraging artificial intelligence and guided generation can save the computing system additional computational resources that would have been otherwise expended for employing expensive naive computer vision-based conversion process, which are oftentimes performed over countless iterations to obtain the final result. These approaches would also conserve any computational resources that would be needed for the computing system to model and/or understand the technical differences between a cinematic, rectilinear environment and an experiential, spherical environment, such as scene semantic analysis, focal point identification, and viewer pattern prediction.

These technical advantages may be appreciated, for example, in resource-constrained environments and large-scale media creation and processing systems. The overall computational efficiency of these systems may be improved as a result and the conserved resources may be reallocated for other tasks and/or additional refinement on those tasks.

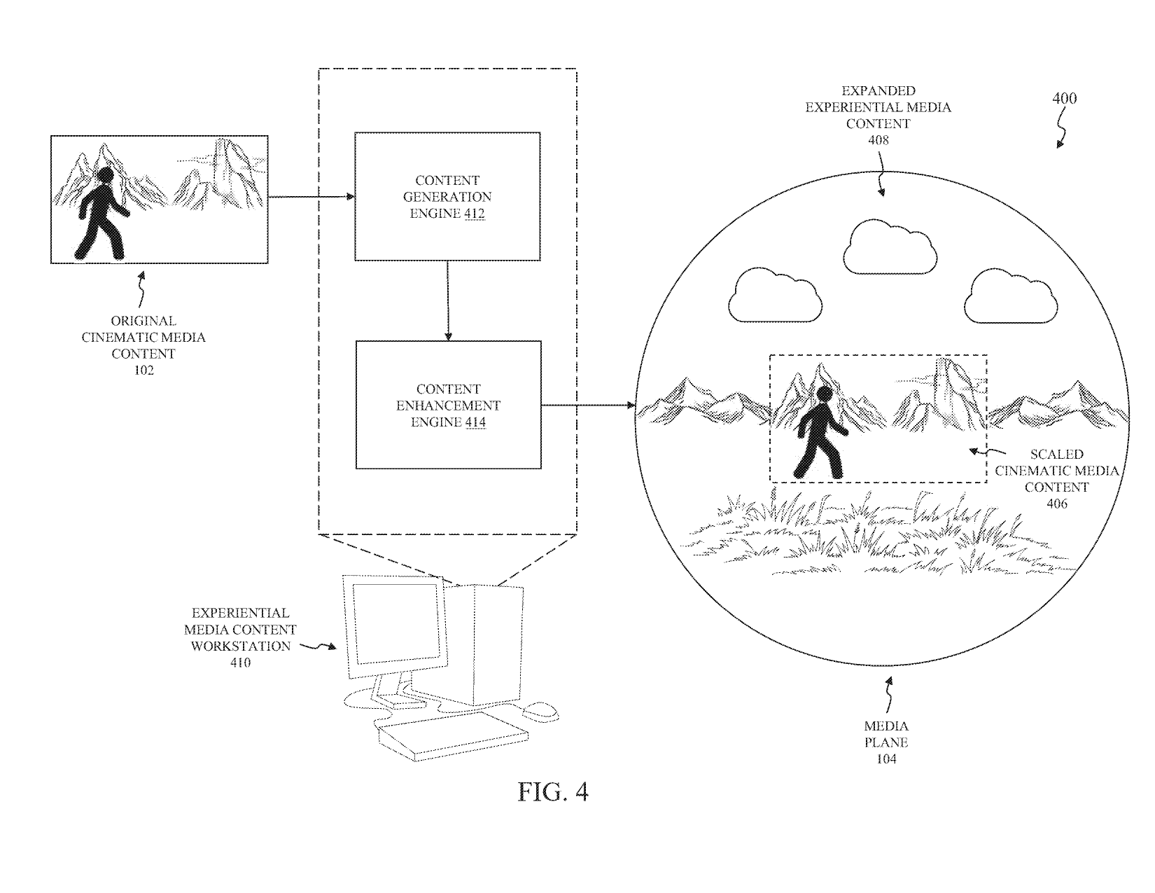

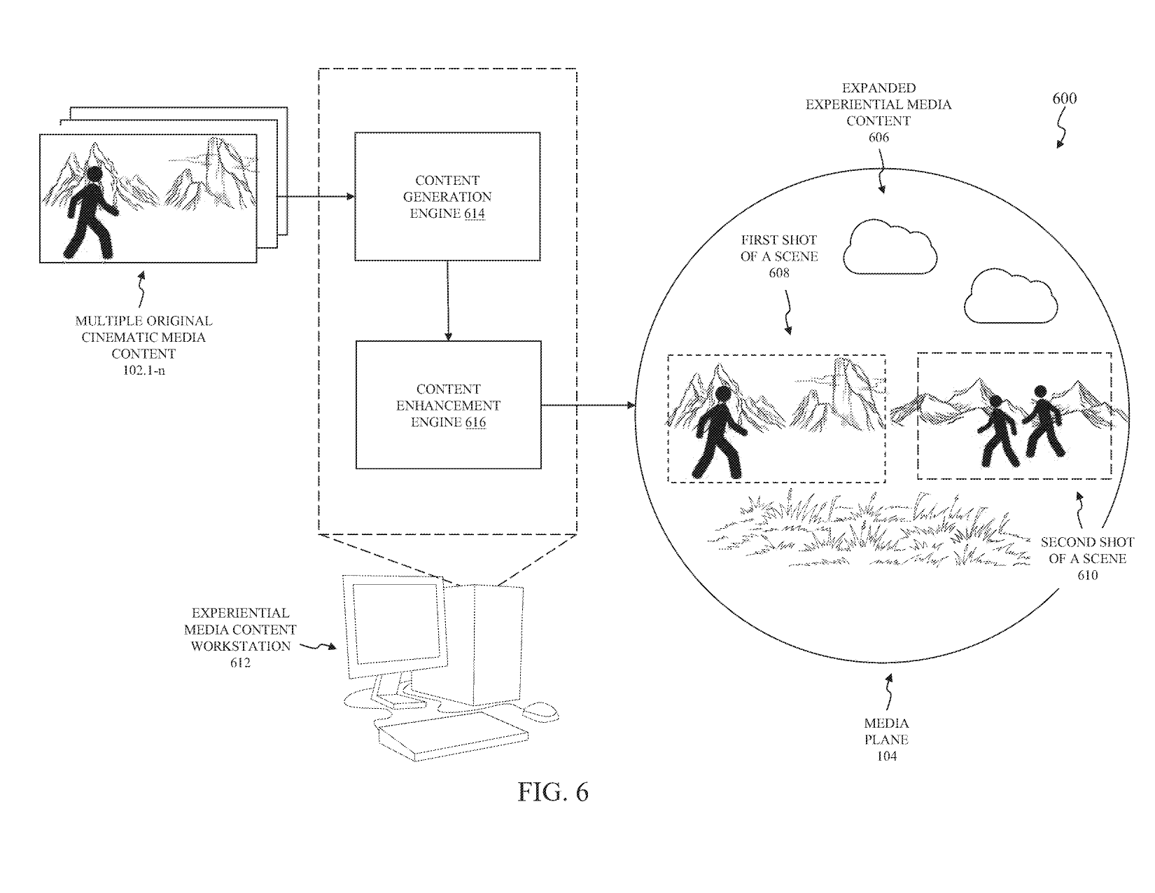

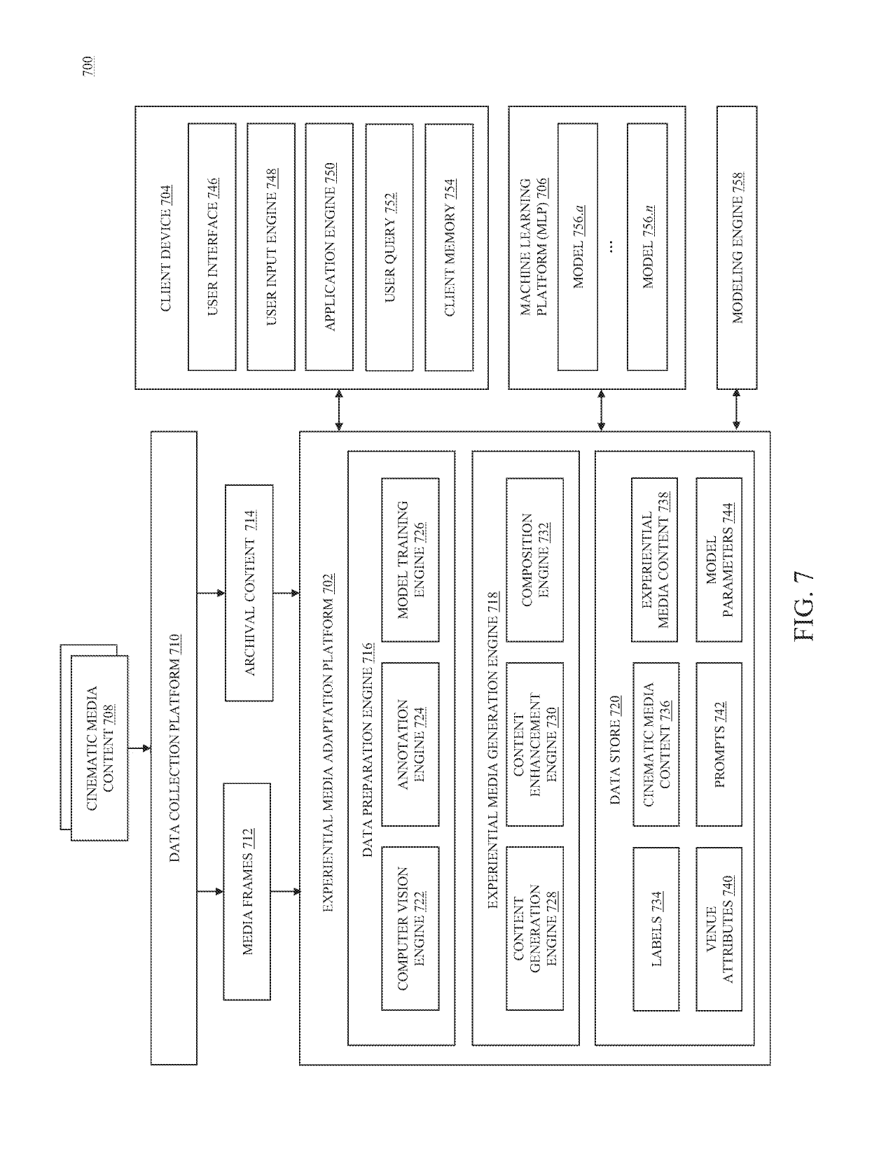

Various aspects of this disclosure may be implemented using and/or may be a part of the example experiential media content workstations shown in FIG. 4 and FIG. 6 and/or the example experiential media adaptation platform shown in FIG. 7. It is noted, however, that these environments are provided solely for illustrative purposes, and are not limiting. Aspects of this disclosure may be implemented using and/or may be part of environments different from and/or in addition to the experiential media content workstations or the experiential media adaptation platform, as will be appreciated by persons skilled in the relevant art(s) based on the teachings contained herein.

FIG. 4 illustrates a high-level pictorial representation of an example experiential media adaptation system 400, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

Example experiential media adaptation system 400 may include original cinematic media content 102, media plane 104, and experiential media content workstation 410. In some embodiments, experiential media adaptation system 400 may convert original cinematic media content 102 into an expanded experiential media content 408 and may present, for example, display, mirror, beam, playback, project, or the like, expanded experiential media content 408 on media plane 104. In some embodiments, expanded experiential media content 408 may include original cinematic media content 102 as scaled cinematic media content 406. Experiential media adaptation system 400 may align a final resolution of scaled cinematic media content 406 with a resolution of media plane 104 and/or scale scaled cinematic media content 406 until an immersion threshold pertaining to media plane 104 is reached. As depicted in FIG. 4, expanded experiential media content 408 may include content inferred from original cinematic media content 102 (e.g., clouds, grass, additional mountain skyline, etc.). In some embodiments, the inferred content may be generated by experiential media adaptation system 400 such that the inferred content remains faithful to the original technical design and direction of original cinematic media content 102.

In some embodiments, media plane 104 may be accompanied by one or more loudspeakers to playback any audio that is associated with an event, which are not shown in FIG. 4 for the sake of simplicity. In some embodiments, the one or more loudspeakers may include a proscenium array loudspeaker system that is situated at, or near, a proscenium of the venue that media plane 104 is a part of, one or more effects extensions array loudspeaker systems that are situated at, or near, the proscenium array loudspeaker system, and/or one or more environmental array loudspeaker systems that are situated throughout the venue. In some embodiments, the proscenium array loudspeaker system, the one or more effects extensions array loudspeaker systems, and/or the one or more environmental array loudspeaker systems can include one or more super tweeters, one or more tweeters, one or more mid-range speakers, one or more woofers, one or more subwoofers, and/or one or more full-range speakers to provide some examples.

In the exemplary embodiment illustrated in FIG. 4, experiential media content workstation 410, an exemplary embodiment of which is to be described in further detail below, may include and execute a content generation engine 412 and a content enhancement engine 414, as described herein. Although experiential media content workstation 410 is illustrated as being a computer workstation in FIG. 4, this is for exemplary purposes only. Those skilled in the relevant art(s) will recognize that experiential media content workstation 410 can be any suitable electrical, mechanical, and/or electro-mechanical device that can execute content generation engine 412 and/or content enhancement engine 414. This suitable electrical, mechanical, and/or electro- mechanical device can include, without limitation, a supercomputer, a mainframe computer, a minicomputer, a personal computer (PC), a laptop, or notebook, computer, a smartphone, an embedded computer, a server, a wearable computer, and/or a gaming console, among others.

Content generation engine 412 and/or content enhancement engine 414, examples of which are to be described in further detail below, can represent one or more software tools that can be executed by one or more electrical, mechanical, and/or electro-mechanical devices that will be apparent to those skilled in the relevant art(s) without departing from the spirit and scope of the present disclosure. Those skilled in the relevant art(s) will recognize that embodiments of the disclosure described herein may be implemented in hardware, firmware, software, or any combination thereof without departing from the present disclosure. Further, those skilled in the relevant art(s) will recognize that firmware, software, routines, instructions, or the like may be described herein as performing certain actions. However, it should be appreciated that such descriptions are merely for convenience and that such actions in fact result from one or more electrical, mechanical, and/or electro-mechanical devices executing the firmware, software, routines, instructions, or the like.

Alternatively or additionally, those skilled in the relevant art(s) will recognize that embodiments of the disclosure described herein may also be implemented as instructions stored on a machine-readable medium, which may be read and executed by one or more processors without departing from the present disclosure. A machine-readable medium may include any mechanism for storing in a form readable by a machine, such as a computing device to provide an example. For example, a machine-readable medium may include read only memory (ROM), random access memory (RAM), magnetic disk storage media, optical storage media, flash memory devices, and the like.

In some embodiments, experiential media content workstation 410 may execute content generation engine 412 to generate various content from original cinematic media content 102. As a few non-limiting examples, content generation engine 412 may generate inferred content of one or more objects within original cinematic media content 102. As a result, content generation engine 412 may produce one or more expanded frames that align with a resolution of media plane 104, for example. Content generation engine 412 may also generate one or more video frames to obtain one or more temporal extension videos. Content generation engine 412 may also generate one or more guidance images. Additional examples and functionality will be explained in further detail hereafter, particularly with respect to FIG. 7.

Experiential media content workstation 410 may also execute content enhancement engine 414 to enhance various content generated by content generation engine 412. As a few non-limiting examples, content enhancement engine 414 may upscale one or more frames generated by content generation engine 412, for example, to align the one or more frames with a resolution of media plane 104. Content enhancement engine 414 may also refine one or more frames generated by content generation engine 412 and/or one or more frames it has processed until a pre-defined temporal coherence threshold is met. Content enhancement engine 414 may also refine one or more frames generated by content generation engine 412 and/or one or more frames it has processed to align with an immersion threshold for a venue. Additional examples and functionality will be explained in further detail hereafter, particularly with respect to FIG. 7.

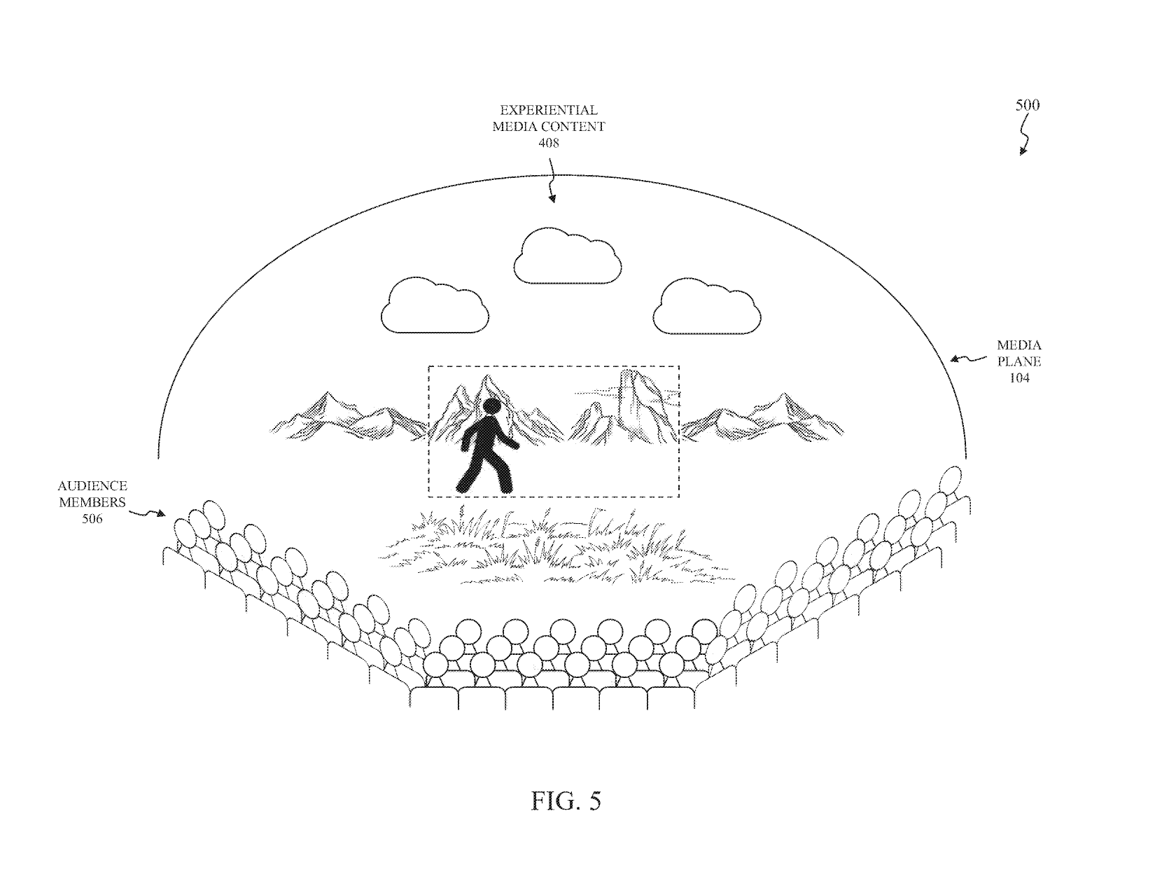

FIG. 5 illustrates an example media plane display environment 500, according to some embodiments. Media plane display environment 500 may include experiential media content 408 displayed on media plane 104. Media plane display environment 500 may also include audience members 506 that are viewing media plane 104. In contrast with scaled cinematic media content 202.a (of FIG. 3A) and scaled cinematic media content 202.b (of FIG. 3B), which possess lower data fidelity and cause perceptive dissonance in audience members 306.a and 306.b respectively, experiential media content 408 may possess high data fidelity and cause perceptive consonance in audience members 506. This perceptive consonance may manifest as measurable consistencies with an expected display size (e.g., objects depicted by experiential media content 408 are the same or about the same size as their real-world counterparts). For example, a person depicted by experiential media content 408 may be the same or about the same size as one or more of audience members 506.

FIG. 6 illustrates a high-level pictorial representation of another example experiential media adaptation system 600, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 6, as will be understood by a person of ordinary skill in the art.

Example experiential media adaptation system 600 may include multiple original cinematic media content 102.1–n, media plane 104, and experiential media content workstation 612. Example experiential media adaptation system 600 may be similar to example experiential media adaptation system 400 (of FIG. 4). In some embodiments, experiential media adaptation system 600 may convert original cinematic media content 102 into an expanded experiential media content 606 and display expanded experiential media content 606 onto media plane 104. In some embodiments, expanded experiential media content 606 may include one or more frames of multiple original cinematic media content 102.1–n. As depicted in FIG. 6, expanded experiential media content 606 may include a first shot of a scene 608. First shot of a scene 608 may be a scaled frame of one or more frames included within multiple original cinematic media content 102.1–n (e.g., original cinematic media content 102.1 scaled to align with a target resolution and/or immersion threshold of a venue that media plane 104 is a part of). Expanded experiential media content 606 may also include a second shot of a scene 610. Second shot of a scene 610 may be another scaled frame of one or more frames included within multiple original cinematic media content 102.1–n (e.g., original cinematic media content 102.3 scaled to align with a target resolution of media plane 104). In some embodiments, second shot of a scene 610 may belong to another frame or sequence of frames within the same cinematic shot as first shot of a scene 608. In some embodiments, second shot of a scene 610 may also be scaled by a different value to align with a resolution of media plane 104 and/or an immersion threshold of a venue that media plane 104 is a part of.

In some embodiments, different objects may appear on different, separate frames of cinematic media content 102.1–n but be part of the same shot(s). This may, for example, be a result of a technical design and direction of multiple original cinematic media content 102.1–n and/or the limited field of view offered by rectilinear or cinematic display formats. However, in an experiential adaptation, the different objects that separately appear on different frames would be part of the same environment and be visible within the wider field of view. As such, expanded experiential media content 606 may depict a consolidated and/or reconstructed environment where one or more shots take place in multiple original cinematic media content 102.1–n.Expanded experiential media content 606 may also display the one or more different objects involved in the same shot or series of shots in the same view. Alternatively or additionally, expanded experiential media content 606 may include content inferred from multiple original cinematic media content 102.1–n (e.g., clouds, grass, additional mountain skyline, etc.). In some embodiments, the inferred content may be generated by experiential media adaptation system 600 such that the inferred content remains faithful to the original technical design and direction of multiple original cinematic media content 102.1–n.

In some embodiments, media plane 104 may be accompanied by one or more loudspeakers to playback any audio that is associated with an event, which are not shown in FIG. 6 for the sake of simplicity. In some embodiments, one or more loudspeakers may include a proscenium array loudspeaker system that is situated at, or near, a proscenium of a venue that media plane 104 is a part of, one or more effects extensions array loudspeaker systems that are situated at, or near, the proscenium array loudspeaker system, and/or one or more environmental array loudspeaker systems that are situated throughout the a venue. In some embodiments, the proscenium array loudspeaker system, the one or more effects extensions array loudspeaker systems, and/or the one or more environmental array loudspeaker systems can include one or more loudspeakers that can include one or more super tweeters, one or more tweeters, one or more mid-range speakers, one or more woofers, one or more subwoofers, and/or one or more full-range speakers to provide some examples.

In the exemplary embodiment illustrated in FIG. 6, experiential media content workstation 612, an exemplary embodiment of which is to be described in further detail below, may similarly include and execute a content generation engine 614 and a content enhancement engine 616, as described herein. Although experiential media content workstation 612 is illustrated as being a computer workstation in FIG. 6, this is for exemplary purposes only. Those skilled in the relevant art(s) will recognize that experiential media content workstation 612 can be any suitable electrical, mechanical, and/or electro-mechanical device that can execute content generation engine 614 and/or content enhancement engine 616. This suitable electrical, mechanical, and/or electro-mechanical device can include, without limitation, a supercomputer, a mainframe computer, a minicomputer, a personal computer (PC), a laptop, or notebook, computer, a smartphone, an embedded computer, a server, a wearable computer, and/or a gaming console, among others.

Content generation engine 614 and/or content enhancement engine 616, examples of which are to be described in further detail below, may be similar to content generation engine 412 and content enhancement engine 414 (of FIG. 4) and can represent one or more software tools that can be executed by one or more electrical, mechanical, and/or electro-mechanical devices that will be apparent to those skilled in the relevant art(s) without departing from the spirit and scope of the present disclosure. Those skilled in the relevant art(s) will recognize that embodiments of the disclosure described herein may be implemented in hardware, firmware, software, or any combination thereof without departing from the present disclosure. Further, those skilled in the relevant art(s) will recognize that firmware, software, routines, instructions, or the like may be described herein as performing certain actions. However, it should be appreciated that such descriptions are merely for convenience and that such actions in fact result from one or more electrical, mechanical, and/or electro-mechanical devices executing the firmware, software, routines, instructions, or the like.

Alternatively or additionally, those skilled in the relevant art(s) will recognize that embodiments of the disclosure described herein may also be implemented as instructions stored on a machine-readable medium, which may be read and executed by one or more processors without departing from the present disclosure. A machine-readable medium may include any mechanism for storing in a form readable by a machine, such as a computing device to provide an example. For example, a machine-readable medium may include read only memory (ROM), random access memory (RAM), magnetic disk storage media, optical storage media, flash memory devices, and the like.

In some embodiments, experiential media content workstation 612 may execute content generation engine 614 to generate various content from multiple original cinematic media content 102.1–n. As a few non-limiting examples, content generation engine 614 may consolidate content across one or more frames and/or shots from multiple original cinematic media content 102.1–n (e.g., different objects appearing in different frames or shots). Content generation engine 614 may also generate inferred content of one or more objects within multiple original cinematic media content 102.1–n. As a result,

content generation engine 412 may produce one or more expanded frames that include multiple shots from a sequence of frames in multiple original cinematic media content 102.1–n in a manner that aligns with a resolution of media plane 104 and remains faithful to the technical design and direction of multiple original cinematic media content 102.1–n, for example. Content generation engine 412 may also generate one or more video frames to obtain one or more temporal extension videos. Content generation engine 412 may also generate one or more guidance images. Additional examples and functionality will be explained in further detail hereafter, particularly with respect to FIG. 7.

Experiential media content workstation 612 may also execute content enhancement engine 616 to enhance various content generated by content generation engine 614. As a few non-limiting examples, content enhancement engine 616 may upscale one or more frames generated by content generation engine 614, for example, to align the one or more frames with a resolution of media plane 104. Content enhancement engine 616 may also refine one or more frames generated by content generation engine 614 and/or one or more frames it has processed until a pre-defined temporal coherence threshold is met. Content enhancement engine 616 may also refine one or more frames generated by content generation engine 614 and/or one or more frames it has processed to align with an immersion threshold for a venue. Additional examples and functionality will be explained in further detail hereafter, particularly with respect to FIG. 7.

As with the examples described above with respect to FIGS. 1–6, examples of specific original cinematic media content, scaled cinematic media content, expanded experiential media content, media planes, experiential media content workstations, and audience members have been described herein. However, these examples are not meant to be limiting nor meant to represent an exhaustive list of possible implementations. The scope of the technology disclosed herein is not limited to only these examples, and other implementations are contemplated as appreciated by one skilled in the art.

### EXEMPLARY BLOCK DIAGRAM OF THE EXPERIENTIAL MEDIA ADAPTATION PLATFORM

FIG. 7 illustrates an example block diagram of an experiential media adaptation platform architecture 700, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 7, as will be understood by a person of ordinary skill in the art.

Example experiential media adaptation platform architecture 700 may include an experiential media adaptation platform 702, a client device 704, a machine learning platform (MLP) 706, cinematic media content 708, a data collection platform 710, media frames 712, and archival content 714. In some aspects, example experiential media adaptation platform architecture 700 may be implemented partially or entirely at client device 704. Alternatively or additionally, in some embodiments, example experiential media adaptation platform architecture 700 may be implemented partially or entirely at third party servers or within the cloud. In such aspects, client device 704, experiential media adaptation platform 702, machine learning platform 706, and data collection platform 710 may be communicatively coupled with each other via one or more networks such as an ad hoc network, an intranet, an extranet, a virtual private network (VPN), a local area network (LAN), a wireless LAN (including Wi-Fi, mesh networks, Bluetooth, near-field communication, etc.), a wide area network (WAN), a wireless wide area network (WWAN), a metropolitan area network (MAN), a portion of the Internet, a portion of the Public Switched Telephone Network (PSTN), a cellular telephone network, a wireless network, a WiMax network, any other type of network, or a combination of two or more such networks.

In some embodiments, experiential media adaptation platform 702 may include a data preparation engine 716, an experiential media generation engine 718, and a data store 720. In some embodiments, experiential media adaptation platform 702 may be implemented as one or more servers and/or one or more cloud servers. Experiential media adaptation platform 702 may also be implemented as a variety of centralized or decentralized computing devices. For example, experiential media adaptation platform 702 may operate on a mobile device, a laptop computer, a desktop computer, grid-computing resources, a virtualized computing resource, cloud computing resources, peer-to-peer distributed computing devices, a server farm, or a combination thereof. Experiential media adaptation platform 702 may be centralized in a single device, distributed across multiple devices within a cloud network, distributed across different geographic locations, or embedded within a network.

In some embodiments, experiential media adaptation platform 702 may receive media frames 712 and archival content 714 collected by data collection platform 710. In some embodiments, data collection platform 710 may receive and/or process cinematic media content 708 to obtain media frames 712 and archival content 714. In some embodiments, cinematic media content 708 may include any visual and/or audio materials that encompass creative works associated with the production and distribution of a cinematic film, including but not limited to final video footage, raw source images or video footage, behind-the-scenes material or documentation, concept art, storyboards, reference images, intellectual property, and other related assets, as well as one or more portions, sections, or subsections thereof. Media frames 712 may include the image frames of the raw source footage. Archival content 714 may include supplementary material to the image frames of the raw source footage, such as but not limited to behind-the-scenes material, concept art, storyboards, reference images, and the like. In some embodiments, data collection platform 710 may implement a fully automated data collection pipeline. The pipeline may employ various technological approaches such as, but not limited to, web scraping, data mining algorithms, semantic analysis, and natural language processing on online data related to cinematic media content 708, providers of cinematic media content 708, and/or content derived from cinematic media content 708.

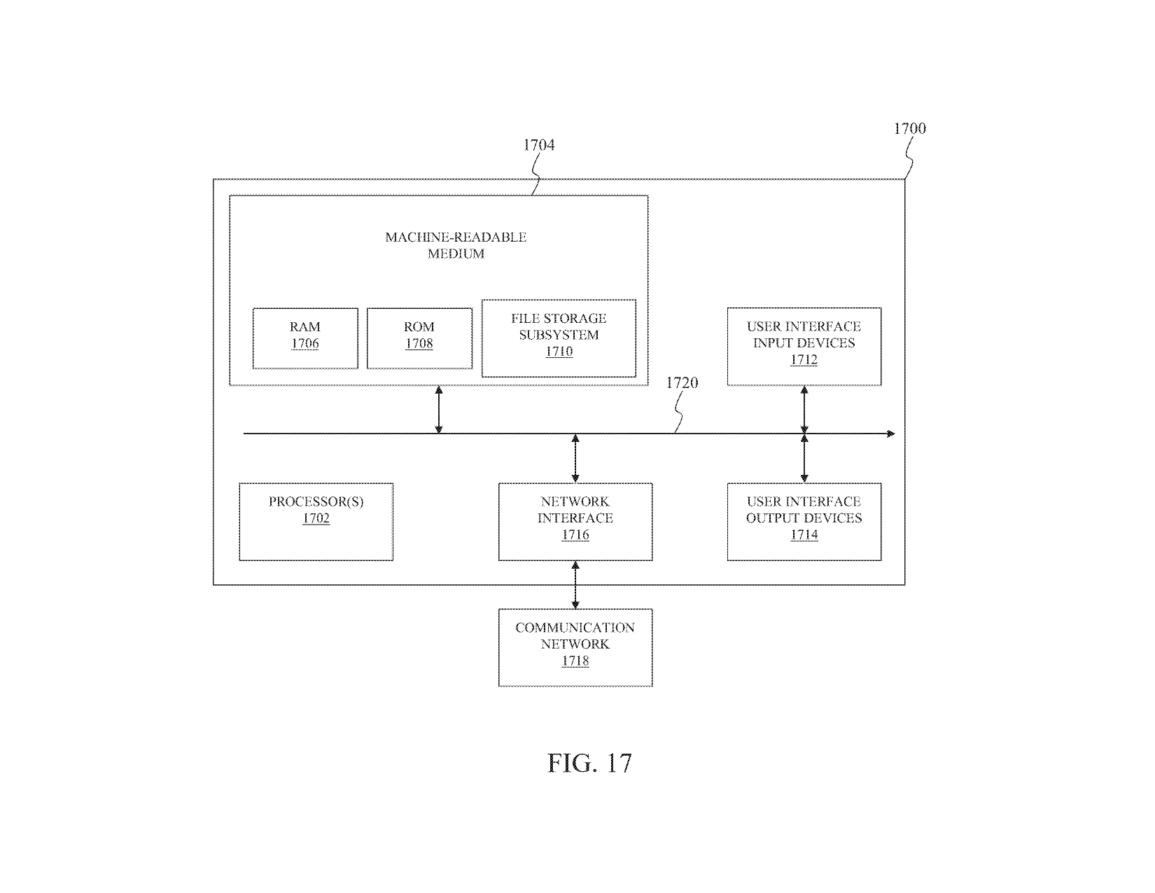

In some embodiments, data store 720 may store various data used by experiential media adaptation platform 702, including labels 734, cinematic media content 736, experiential media content 738, venue attributes 740, prompts 742, model parameters 744, and temporal coherence thresholds. For example, data store 720 may store media frames 712 and/or archival content 714 received from data collection platform 710 as cinematic media content 736. Data store 720 may be stored, for example, in a volatile memory (e.g., random access memory (RAM)), a non-volatile storage device (e.g., a disk), or in a distributed and/or redundant manner across multiple memories and/or storage devices. Data store 720 may be a relational data store. In some aspects, data store 720 is managed by and accessed via a corresponding database management system (DBMS), which is not shown in FIG. 7 for the sake of simplicity. Data store 720 and the corresponding DBMS may be implemented on one or more computer systems, such as computer system 1700 as described below in reference to FIG. 17. Data store 720 and the corresponding DBMS may also be implemented on one or more servers of an enterprise network and/or a cloud computing network.

Machine learning platform (MLP) 706 may be a distributed computing systems configured to execute one or more image and video generation models, such as models 756.a through 756.n (collectively, “models 756”). In some embodiments, models 756 may be diffusion-based, transformer-based, flow-based, and/or neural network-based models trained on large amounts of visual and multimodal data. Models 756 may employ various model architectures including, but not limited to, standard diffusion or latent diffusion models (e.g., Stable Diffusion 1.0, 1.5, and 2.0), rectified flow models, vision transformers, multimodal diffusion transformers (MM-DiT), video vision transformers, and other multimodal models capable of processing diverse input modalities.

Various components of experiential media adaptation platform 702 may communicate with MLP 706 and models 756 to perform various tasks, including but not limited to outpainting, inpainting, object completion, object generation, video extension, video interpolation, motion transfer, and temporal coherence preservation. In some embodiments, MLP 706 may leverage one or more conditioning mechanisms to influence the inference process. “Inference” as used herein may refer to the process of running data points through a trained or partially trained machine learning model to generate outputs. The “inference” process (e.g., executing a model on data) may be distinct from “inferred content” (e.g., generating content with context/conditioning). In some embodiments, these architectures may use pre-trained text encoders (e.g., CLIP, T5, etc.) and/or fine-tuned text encoders to provide text conditioning information during the inference process (e.g., textual descriptions of an intended result). Alternatively or additionally, these architectures may provide image or media content, masks specifying regions to be generated or preserved, motion vectors, optical flow estimations, or explicit trajectory guidance as conditioning information.

In some embodiments, experiential media adaptation platform 702 may include an MLP interface (not shown) to facilitate communications between various components of experiential media adaptation platform 702 and MLP 706. In some embodiments, MLP 706 may leverage third-party, enterprise, or cloud-based services that host and maintain models 756. Alternatively or additionally, various components of experiential media adaptation platform 702 may communicate with MLP 706 directly (e.g., via public API calls, a virtual private cloud connection, etc.) or via an MLP interface. Alternatively or additionally, MLP 706 may exist within experiential media adaptation platform 702. In such embodiments, MLP 706 may implement and execute models 756 locally.

In some embodiments, models 756 may include specialized adaptations such as Low-Rank Adaptations (LoRAs) and control networks to guide and condition the inference process, which may result in more accurate and faithful outputs. These adaptations may allow for fine-tuning and customization of base models for specific domains, styles, or use cases without requiring full model retraining. A control network may be a separate input channel that is injected into an image latent space, such as a neural network architecture to add spatial conditioning controls to large, pre-trained diffusion models. A few non-limiting examples of control networks may include, but are not limited to, human/character poses, Canny edge maps, M-LSD lines, HED maps, scribble maps, segmentation maps, depth maps, normal maps, motion key frames, trajectory maps, physics-based simulations, and the like. This additional conditioning information via control networks may be referred to herein as “control maps.” Control maps may allow more precise guidance of the generation process. In some embodiments, these adaptations may capture domain-specific motion patterns (e.g., how an object behaves or moves in a specific piece of cinematic media). These adaptations may also leverage resolution-dependent timestep schedules to account for varying pixel densities across different resolutions.

In some embodiments, models 756 may implement multimodal architectures that can process text, image, video, and/or audio modalities through separate streams. In some embodiments, each data stream may be configured with their own dedicated set of parameters. Models 756 may include transformer-based architectures that process latent representations through self-attention and/or cross-attention mechanisms. These architectures may implement tokenization/patching operations that decompose latent representations into sequences of tokens, spatial patches, and/or spacetime patches that represent a corresponding region of the input. For example, image-based embodiments may apply 2×2 patching to flatten latent pixel representations of dimensions height × width × color (h×w×c) to a spatial patch encoding sequence of length (h/2) × (w/2). In video generation embodiments, models 756 may incorporate temporal dimensions, where latent representations of dimensions time × height × width × color (t×h×w×c) may be decomposed using 2×2×2 spatiotemporal patching. This operation may flatten the latent representations into a spatiotemporal patch encoding sequence of length (t/2) × (h/2) × (w/2). This representation allows models 756 to learn correlations within frames but also across sequential frames, potentially capturing motion dynamics and maintaining temporal consistency. When calculating attention, the spatiotemporal patches may attend to each other to establish long-range dependencies and improve the generation process.

Generally, prompts 742 may refer to unimodal or multimodal instructions that are fed into a machine learning platform (e.g., MLP 706). Prompts 742 may include contexts, user instructions, system instructions, and/or other metadata for guiding MLP 706 towards generating a desired output. For example, prompts 742 may include positive prompts that describe desired elements to include in the generated output, negative prompts that specify elements to exclude, and prompt weighting that determines the relative importance of different elements within the prompt. Prompt weighting may allow MLP 706 to emphasize certain aspects of the generated content over others (e.g., color, style, composition, etc.) and provide finer control.

In some embodiments, prompts 742 might specify visual elements, styles, lighting conditions, and composition elements. Alternatively or additionally, prompts may describe motion characteristics, transitions between scenes, camera movements, and temporal developments in the content. For example, a prompt might specify “a camera slowly panning around a sculpture as the scene transitions from morning to evening,” providing guidance over the visual content and how the content should change over time. Prompts 742 may come in many different forms and support various input-to-output transformations, such as text-to-image (txt2img), image-to-image (img2img), image-to-video (img2vid), and video-to-video (vid2vid) operations. These prompts may also include any conditioning information, such as the non-limiting examples described above (control maps, reference images, other data streams, and the like), to guide the inference process. As additional non-limiting examples, prompts may include motion maps, storyboards indicating key frames, and audio tracks that should synchronize with visual elements in the output.

Model parameters 744 may define one or more configurations for any inference processes performed by MLP 106 and models 756. These parameters may include a

Classifier-Free Guidance (CFG) scale that controls adherence to the prompt, seed values for reproducibility of outputs, a number of sampling steps, input/output resolution specifications, sampler type (e.g., Euler A, DPM++ 2M Karras, DDIM). In some embodiments, model parameters 744 may include additional parameters such as frame rate, motion smoothness, target video durations, and temporal consistency weights that balance frame quality and inter-frame coherence. In some embodiments, time step sampling strategies may be optimized toward perceptually relevant scales using techniques such as logit-normal or mode sampling with heavy tails. In some embodiments, the sampling strategy may focus computational resources on the noise levels that most significantly impact the perceived quality of the output. In other embodiments, the sampling strategy may allocate additional resources to noise levels that affect temporal consistency. In such embodiments, MLP 706 may produce smooth transitions between frames while maintaining high-quality visual content within each frame.

Venue attributes 740 may define one or more configurations pertaining to a specific venue (e.g., a venue or a virtual venue environment) for influencing the experiential media adaptation process. In some embodiments, venue attribute 740 may include a resolution of media plane 104. In some embodiments, the resolution of a venue may be a resolution of a media plane that is part of the venue (e.g., media plane 104 of FIG. 5). The media plane may be a spherical and/or experiential display. For example, the resolution of the venue may be 8192 pixels x 8192 pixels or 16384 pixels by 16384 pixels. The resolution of the venue may also be a resolution of a VR environment.

In some embodiments, venue attributes 740 may also include one or more immersion thresholds. An “immersion threshold” may refer to any perceptual loss function or heuristic that can guide content scaling and/or post-processing operations to align a piece of media with real-world proportions and spatial relationships. These one or more immersion thresholds may quantify a degree to which visual content (e.g., cinematic media content 736 or one or more frames of cinematic media content 736) should be adjusted in a media plane to generate resulting media that creates immersion and matches a natural scale with the real-world (e.g., media that has high data fidelity with respect to the real-world). In some embodiments, the one or more immersion threshold may include one or more perceptual factors including, but not limited to, object/subject size relativity, spatial depth cues, perspective accuracy, and human anthropometric measurements.

For example, experiential media adaptation platform 702 may analyze a current object scaling of one or more frames of cinematic media content 736 against established perceptual baseline values and calculate a difference or loss from those baseline values. If the one or more immersion thresholds are not met, experiential media adaptation platform 702 may apply one or more transformations to minimize the difference or loss, such as selected scaling, perspective correction, or depth-aware adjustments. In some embodiments, experiential media adaptation platform 702 may also adapt these transformations dynamically based on viewing parameters, display characteristics, and the type of content being displayed. For example, experiential media adaptation platform 702 may apply different weighting to foreground objects (e.g., that may be closer to one or more audience members of a venue) verses background objects and/or environment context.

Data preparation engine 716 may perform various preprocessing and data preparation tasks for experiential media adaptation platform 702. In some embodiments, data preparation engine 716 may primarily be responsible for preparing cinematic media content data (e.g., media frames 712 and/or archival content 714) and machine learning models (e.g., cinematic media content 736) into experiential media content (e.g., experiential media content 738) efficiently and faithfully. Data preparation engine 716 may include a computer vision engine 722, an annotation engine 724, and a model training engine 726. In some embodiments, computer vision engine 722, annotation engine 724, and model training engine 726 may be separate computing systems. Alternatively or additionally, any combination or subcombination of computer vision engine 722, annotation engine 724, and model training engine 726 may be or be part of the same system computing system.

Computer vision engine 722 may perform various object and subject segmentation tasks to identify and/or extract objects from media frames (e.g., media frames 712) and/or content related to media frames (e.g., archival content 714). Computer vision engine 722 may generate image segments or segmentation masks that can be leveraged as part of a machine learning training and/or fine-tuning pipeline to enhance the quality and faithfulness of resultant images. Computer vision engine 722 may employ various segmentation strategies, such as semantic segmentation (e.g., FCN, DeepLab, PSPNet), instance segmentation (e.g., Mask R-CNN, YOLACT, PointRend), panoptic segmentation (e.g., Panoptic FPN, Panoptic DeepLab), and transformer-based approaches (e.g., DETR, Mask2Former, Segment Anything Model), and other segmentation methods that will be apparent to those skilled in the relevant art(s) without departing from the spirit and scope of the present disclosure. These methods may leverage various architectural components, such as convolutional neural networks, transformer encoders and decoders, attention mechanisms, and feature pyramid networks to detect object boundaries and generate precise segmentation masks. Computer vision engine 722 may also employ various additional computer vision techniques, such as image decimation or control map generation. For example, computer vision engine 722 may perform one or more computer vision techniques (e.g., pose estimation, edge-detection, depth generation, pose estimation, etc.) to obtain any of the control maps described above (e.g., human/character poses, Canny edge maps, M-LSD lines, HED maps, scribble maps, segmentation maps, depth maps, normal maps, motion key frames, trajectory maps, physics-based simulations, etc.).

In some embodiments, computer vision engine 722 may also leverage multi-scale processing and specialized loss functions to handle more complex scenes that contain varying object sizes, occlusions, and lighting conditions. For example, computer vision engine 722 may leverage Atrous Spatial Pyramid Pooling (ASPP) methods to process images at multiple resolutions simultaneously. As another example, computer vision engine 722 may employ a combination of binary cross-entropy and dice loss (BCE-Dice loss) to address class imbalance issues. Alternatively or additionally, computer vision engine 722 may implement focal loss which dynamically adjusts weights given to pixels that are hard to segment to focus training on challenging boundaries and/or smaller objects. Other loss functions that will be apparent to those skilled in the relevant art(s) without departing from the spirit and scope of the present disclosure are also contemplated.

Annotation engine 724 may provide various functionality for annotating segmented objects, image segments, or segmentation masks with descriptive tags. In some embodiments, these descriptive tags may be saved inside data store 720 as labels 734. Labels 734 may describe various aspects of one or more objects, such as what the object is, what actions the object is performing, and qualifiers about the object’s appearance, style, or other attributes. Annotation engine 724 may employ an automated pipeline and/or use one or more human-in-the-loop configurations. In some embodiments, a user or system may generate, verify, and/or enhance descriptions for image segments or media frames (e.g., from an initial version of labels 734 to produce labels 734). In some embodiments, annotation engine 724 may employ one or more machine learning models (e.g., models 756) including vision-language models such as a CLIP, BLIP, OFA, and the like to generate initial versions of labels 734, which may then be verified and/or enhanced by a user or system. Alternatively or additionally, labels 734 may be provided by users through an interface (e.g., client device 704). In some embodiments, annotation engine 724 may employ one or more active learning techniques to prioritize which image segments require human verification, thus improving the annotation workflow. The resulting annotated dataset and/or any portions thereof may enable downstream training and/or fine-tuning of machine learning models (e.g., models 756) to enhance content generation efficiency and faithfulness. Labels 734 may serve as additional conditioning inputs and guidance signals during model training or inference to improve object recognition and more contextualized generation.

Model training engine 726 may employ various training mechanisms to train, further train, or fine-tune one or more models running on MLP 706 (e.g., models 756). In some embodiments, model training engine 726 may be part of MLP 706 or communicate with MLP 706 to train, further train, or fine-tune models 756. For example, model training engine 726 may leverage annotated images, image segments, and/or segmentation to train, further train, or fine-tune models 756. Model training engine 726 may employ various training and fine-tuning approaches to leverage the segmented and annotated data. For general model training, model training engine 726 may employ supervised learning techniques where the annotated data serves as ground truth for optimization objectives. As used herein, “ground truth” may refer to the correct answer or answers to the problem or scenario that a machine learning system is being trained on.

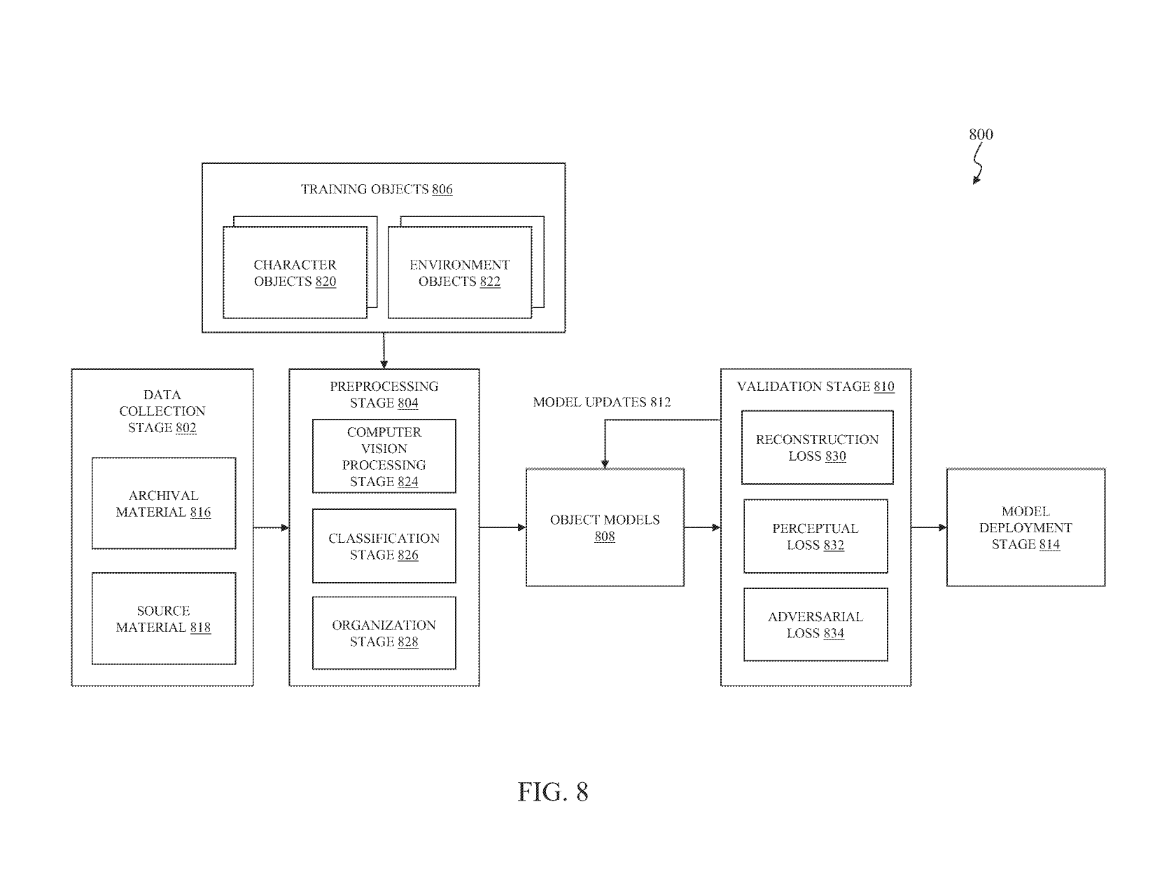

Model training engine 726 may employ fine-tuning strategies such as transfer learning, where one or more pre-trained models are adapted to specific tasks by updating model weights (e.g., using the data annotated by annotation engine 724). Model training engine 726 may also employ parameter-efficient fine-tuning methods such as LoRA, adapter tuning, or prompt tuning, which may modify only a subset of model parameters while keeping the base model frozen. Alternatively or additionally, model training engine 726 may also leverage contrastive learning approaches to better learn representations of objects and their attributes by contrasting positive pairs (correct object-description matches) against negative examples. Model training engine 726 may also employ any of one or more optimization techniques including, but not limited to, gradient accumulation, mixed precision training, and distributed training across multiple computing devices to handle large datasets of segmented and/or annotated images more efficiently. Additional examples of training will be discussed in further detail below, with respect to FIG. 8.

Experiential media generation engine 718 may perform various generation and enhancement functionalities across experiential media adaptation platform 702. In some embodiments, experiential media generation engine 718 leverage data prepared by data preparation engine 716 and/or one or more machine learning models trained or fine-tuned by data preparation engine 716 for adapting cinematic media content (e.g., cinematic media content 736) into experiential media content (e.g., experiential media content 738) efficiently and faithfully. Experiential media generation engine 718 may include a content generation engine 728, a content enhancement engine 730, and a composition engine 732. In some embodiments, content generation engine 728, content enhancement engine 730, and composition engine 732 may be separate computing systems. Alternatively or additionally, any combination or subcombination of content generation engine 728, content enhancement engine 730, and composition engine 732 may be or be part of the same system computing system.

Content generation engine 728 may perform various content generation tasks for experiential media adaptation platform 702 using, for example, cinematic media content 736, one or more media frames of cinematic media content 736, archival content related to cinematic media content 736, data prepared by data preparation engine 716, and content enhanced by content enhancement engine 730. In some embodiments, content generation engine 728 may generate inferred content from one or more objects in one or more frames of a cinematic media content 736 in a cinematic resolution and/or field of view to obtain one or more expanded frames corresponding to experiential media content 738 in an experiential resolution and/or field of view.

In some embodiments, one or more objects may already exist within the one or more frames being expanded, but those one or more objects may be cut off by the limited resolution and/or field of view, for example, due to the cinematic perspective. In such embodiments, generation engine 728 may generate inferred content for those one or more objects to obtain completed objects to be included in the resultant experiential media content 738, through a process that may be referred to as “object completion.” The inferred content may also be extended and/or outpainted from one or more objects, which may be a process referred to as “object extension.” In some embodiments, one or more objects may not exist in the one or more frames being expanded, but may be part of the same shot of a sequence of frames in cinematic media content 736. For example, a sequence of frames may depict a shot of two characters conversing with each other, but one or more frames of the sequence may depict only one character talking at a time. In such embodiments, generation engine 728 may generate entire objects within one or more frames to obtain all completed objects to be included in one or more frames of a resultant experiential media content 738, through a process that may be referred to as “object generation.” When generating expanded frames, content generation engine 728 may perform either of object completion or object generation alone, sequentially, in parallel, or simultaneously (e.g., in a same query to MLP 706) to generate inferred content for one or more objects.

To perform object completion, content generation engine 728 may identify one or more frames from cinematic media content 736 for which one or more objects may be completed inside an expanded frame for experiential media content 738. As one non-limiting example, content generation engine 728 may identify one frame on which to perform object completion to produce an expanded frame of higher resolution/size. As another non-limiting example, content generation engine 728 may identify two or more frames on which to perform object completion to produce an expanded frame. Content generation engine 728 may also identify one or more context images that are relevant to the one or more objects being completed. For example, content generation engine 728 may identify all the one or more frames within a sequence of frames pertaining to one shot in cinematic media content 736 or any subset thereof as relevant context images. In some embodiments, content generation engine 728 may not perform a context image identification step and proceed with the object completion process in a straight “zero- shot” method (e.g., without providing any additional examples or context), relying on the fine-tuned generalization abilities of models 756.

Content generation engine 728 may also generate a guidance image that defines or outlines an area to be generated in an expanded frame of experiential media content 738. Guidance images may serve as additional structural or contextual conditioning information to influence the generation process. In some embodiments, guidance images may be a lower resolution than the one or more frames of cinematic media content 736. Content generation engine 728 may then define one or more parameters for one or more models running on MLP 706 (e.g., models 756) and one or more queries describing a one or more target outputs for an expanded frame with a completed object. In some embodiments, content generation engine 728 may obtain the one or more parameters and the query from client device 704. Alternatively or additionally, content generation engine 728 may obtain the one or more parameters and the query from data store 720 (e.g., prompts 742 and/or model parameters 744). Content generation engine 728 may then generate inferred content of the one or more objects in the one or more frames of the cinematic media content 736, for example, by querying MLP 706 with the query, the one or more parameters, and the one or more guidance images to produce an expanded frame with the one or more completed objects according to the one or more parameters and the query.

Alternatively or additionally, content generation engine 728 may perform object generation by similarly identifying one or more frames from cinematic media content 736 for which one or more objects may be added into an expanded frame for experiential media content 738. As one non-limiting example, content generation engine 728 may identify one frame on which to perform object generation to produce an expanded frame of higher resolution/size. As another non-limiting example, content generation engine 728 may identify two or more frames on which to perform object generation to produce an expanded frame. Content generation engine 728 may also identify one or more context images that are relevant to the one or more objects being generated that are not in one or more frames of a cinematic media content 736. For example, content generation engine 728 may identify all of the one or more frames within a sequence of frames pertaining to one shot in cinematic media content 736 or any subset thereof as relevant context images. In some embodiments, content generation engine 728 may not perform a context image identification step and proceed with the object generation in a straight “zero-shot” method (e.g., without providing any additional examples or context), relying on the fine-tuned generalization abilities of models 756.

Content generation engine 728 may then generate a guidance image that defines or outlines an area to be generated in an expanded frame of experiential media content 738, which may serve as additional structural or contextual conditioning information to influence the generation process. In some embodiments, guidance images may be a lower resolution than the one or more frames of cinematic media content 736. Content generation engine 728 may then define one or more parameters for one or more models running on MLP 706 (e.g., models 756) and one or more queries describing a one or more target outputs for an expanded frame containing the one or more objects to be generated. In some embodiments, content generation engine 728 may obtain the one or more parameters and the query from client device 704. Alternatively or additionally, content generation engine 728 may obtain the one or more parameters and the query from data store 720 (e.g., prompts 742 and/or model parameters 744). Content generation engine 728 may then generate the one or more objects inside the one or more frames of the cinematic media content 736, for example, by querying MLP 706 with the query, the one or more parameters, and the one or more guidance images to produce an expanded frame with the one or more generated objects according to the one or more parameters and the query.

In some embodiments, content generation engine 728 may leverage and/or communicate with modeling engine 758 to generate a guidance image. In some embodiments, modeling engine 758 may perform various generation, manipulation, rendering, and/or optimization tasks to generate, modify, and visualize two-dimensional and/or three-dimensional representations of digital environments (e.g., “scenes”). In some embodiments, modeling engine 758 may generate scenes for simulating media content, capturing guidance images, and creating other types of media. Modeling engine 758 may include various scene generation technologies, including but not limited to, game engines (e.g., UNREAL ENGINE, UNITY, CRYENGINE, GODOT), 3D modeling software (e.g., BLENDER, MAYA, 3DS MAX, CINEMA 4D), computer-aided design (CAD) or building information modeling (BIM) platforms (e.g., AUTOCAD, REVIT, RHINO), procedural modeling systems (e.g., HOUDINI, SPEEDTREE), real-time rendering frameworks (e.g., DirectX, Vulcan, Metal), photogrammetry software (e.g., REALITYCAPTURE, METASHAPE), point cloud processing tools (e.g., CloudCompare, POINTCAB), neural rendering architectures, physics simulation frameworks, and other modeling systems that will be apparent to those skilled in the relevant art(s) without departing from the spirit and scope of the present disclosure.

In some embodiments, modeling engine 758 may employ neural radiance field (NeRF) technology for scene representation and/or rendering. This may include visualization of various radiant field formats such as Gaussian splats, streamable memory efficient radiance fields (SMERF), plenoptic voxels (Plenoxels), and other volumetric or implicit representations. In some embodiments, the initial generation of these radiance fields may occur in specialized preprocessing pipelines. In such embodiments, modeling engine 758 may provide capabilities for importing, converting, manipulating, and/or rendering these representations within a unified scene graph or environment.

Modeling engine 758 may employ various techniques, such as rasterization, ray tracing, path tracing, photon mapping, and hybrid approaches to generate realistic or stylized images. Alternatively or additionally, modeling engine 758 may leverage acceleration structures (e.g., BVH trees, octrees, sparse voxel octrees) and optimization techniques (e.g., geometry instancing, culling algorithms) to maintain performance while handling more complex scenes. In some embodiments, modeling engine 758 may also implement differentiable rendering pipelines that allow gradient-based optimization of scene parameters. In some embodiments, modeling engine 758 may also provide tools for procedural content generation, allowing the creation of terrain, vegetation, architecture, and any other scene elements based on parametric rules or machine learning models.

In some embodiments, content generation engine 728 (or any other process executing on experiential media adaptation platform 702) may scale a frame from cinematic media content 736 to meet an immersion threshold for an expanded frame and/or result frame of an experiential version of cinematic media content 736 (e.g., experiential media content 738). Content generation engine 728 may insert a scaled frame of cinematic content 736 into a frame or temporary frame of experiential media content 738 (e.g., a frame with a same resolution as a resolution of media plane 104 corresponding to experiential media content 738). Content generation engine 728 may then generate, recreate, or transfer a scene from cinematic media content 736 that the scaled frame is a part of within modeling engine 758.

In some embodiments, the scene may depict a one or more target outputs for a result frame (e.g., a result frame for experiential media content 738). In some embodiments, one or more objects may be added into the scene within modeling engine 758 and positioned in accordance with one or more subsequent or surrounding frames of cinematic media content 736. Alternatively or additionally, one or more objects may be inferred based on reference materials or real-world patterns. For example, a scaled frame from cinematic media content 736 may depict a person character object and a mountain skyline environment object. Continuing this example, when creating the scene in modeling engine 758, the full mountain range may be added, as well as clouds to fill the sky.

Content generation engine 728 may then align the scaled frame with the generated scene. For example, a virtual camera object in modeling engine 758 may be positioned in a manner such that a field of view of the virtual camera object includes the scaled frame at a desired location within the scene. In some embodiments, a desired location may be determined using the immersion threshold for an expanded frame and/or result frame of experiential media content 738. Alternatively or additionally, the desired location may be determined by an immersion threshold for a venue.

Content generation engine 728 may then obtain a guidance image by capturing the scene in modeling engine 758 alongside the scaled frame. In some embodiments, content generation engine 728 may capture the scene material at a lower resolution as compared to the scaled frame from cinematic media content 736. As one non-limiting example, content generation engine 728 may use a previsualization (e.g., “previz”) feature of modeling engine 758 to obtain the one or more guidance images. As such, a guidance image may serve as a general guideline and structural conditioning information for models 756 to fill in finer details of an expanded frame of experiential media content 738.

Alternatively or additionally, content generation engine 728 may obtain a guidance image via one or more of models 756 directly. Content generation engine 728 may define one or more parameters for one or more of models 756 and one or more queries describing one or more target outputs for a guidance image. In some embodiments, content generation engine 728 may obtain the one or more parameters and the query from client device 704. Alternatively or additionally, content generation engine 728 may obtain the one or more parameters and the query from data store 720 (e.g., prompts 742 and/or model parameters 744). As one non-limiting example, content generation engine 728 may specify within the query a resolution value of the one or more target outputs that is lower than the scaled frame. Content generation engine 728 may then generate the one or more guidance images by querying MLP 706 with the query and the one or more parameters to produce a guidance image according to the one or more parameters and the query.

In some embodiments, content generation engine 728 may also provide video generation capabilities, such as temporal image or video extension. Content generation engine 728 may obtain one or more key frames of experiential media content 738. In some embodiments, the one or more key frames of experiential media content 738 may be generated using object completion and/or object generation from one or more frames of cinematic media content 746. Alternatively or additionally, content generation engine 728 may obtain one or more of the key frames through a separate process. In some embodiments, content generation engine 728 (and/or one or more systems within data preparation engine 716) may employ pose estimation techniques (e.g., OpenPose, MediaPipe Pose, DWPose, MMPose, YOLO-Pose, HRNet, PoseNet, AlphaPose, ViTPose, etc.) to obtain one or more pose keypoints on image segments for an object. From these pose keypoints, content generation engine 728 may generate corresponding sets of control maps for generating the one or more key frames. In some embodiments, the one or more pose keypoints may be adjusted to reflect a target pose for a key frame. In some embodiments, the one or more pose keypoints may also need to be converted to a different pose estimation format (e.g., one such as OpenPose that is compatible with ControlNet or another spatial conditioning network). Content generation engine 728 may then generate the one or more key frames with one or more of models 756 and the control map (e.g., via one or more queries describing a one or more target outputs for the one or more key frames for experiential media content 738 and one or more parameters for models 756).

Content generation engine 728 may also generate one or more interpolated frames between one or more key frames for experiential media content 738. In some embodiments, content generation engine 728 may define one or more parameters for one or more of models 756 and one or more queries describing a one or more target outputs for a set of interpolated frames (either individually or in aggregate) between adjacent key frames. For example, the one or more parameters may include a number of interpolated frames to generate and/or a target duration and a one or more target outputs may be “pictures of a dog going from sitting down to sitting up.” Content generation engine 728 may obtain the one or more parameters and the query from client device 704 or data store 720. Content generation engine 728 may then generate the set of interpolated frames by querying MLP 706 with the query and the one or more parameters to produce the interpolated frames according to the one or more parameters and the query. Alternatively or additionally, content generation engine 728 may query MLP 706 with the adjacent key frames to obtain the interpolated frames. Content generation engine 728 may repeat a similar process for each of the key frames obtained, or content generation engine 728 may generate multiple sets of interpolated frames through one query.

Content generation engine 728 may also generate one or more subsequent frames after one or more key frames for experiential media content 738 (e.g., a final key frame within one or more key frames). In some embodiments, content generation engine 728 may define one or more parameters for one or more of models 756 and one or more queries describing one or more target outputs for one or more subsequent frames after a final key frame for experiential media content 738. For example, the one or more parameters may include a number of subsequent frames to generate and/or a target duration and one or more target outputs may be “pictures of a dog walking.” Content generation engine 728 may obtain the one or more parameters and the query from client device 704 or data store 720. Content generation engine 728 may then generate the subsequent frames by querying MLP 706 with the query and the one or more parameters to produce the subsequent frames according to the one or more parameters and the query. Alternatively or additionally, content generation engine 728 may query MLP 706 with the relevant key frames (e.g., a final key frame) to obtain the subsequent frames. Content generation engine 728 may also query MLP 706 with the current set of frames for a sequence (e.g., the one or more key frames and/or one or more interpolated frames) to obtain subsequent frames for the sequence.

Content enhancement engine 730 may perform various content enhancement tasks for experiential media adaptation platform 702 using, for example, cinematic media content 736, one or more media frames of cinematic media content 736, archival content related to cinematic media content 736, data prepared by data preparation engine 716, and content generated by content generation engine 728. In some embodiments, content enhancement engine 730 may upscale a resolution of cinematic media content 736, one or more media frames of cinematic media content 736, data prepared by data preparation engine 716, and/or content generated by content generation engine 728. In some embodiments, content enhancement engine 730 may perform temporal coherence refinement on cinematic media content 736, one or more media frames of cinematic media content 736, data prepared by data preparation engine 716, and/or content generated by content generation engine 728. In some embodiments, content enhancement engine 730 may also perform one or more frame rate-up conversion processes on cinematic media content 736, one or more media frames of cinematic media content 736, data prepared by data preparation engine 716, and/or content generated by content generation engine 728.

In some embodiments, content enhancement engine 730 may upscale one or more frames of experiential media content 738. For example, content enhancement engine 730 may upscale one or more frames of one or more temporal extension videos generated by content generation engine 728. This upscaling process may also be referred to as “super-resolution,” according to some embodiments. These super-resolution techniques may be selected based on a content type, target quality or resolution level, computational requirements, and/or specific visual complexities of the input content. Content enhancement engine 730 may employ various models (e.g., models 756) and architectures for performing super-resolution, including but not limited to super-resolution perceptual image restoration (SUPIR), enhanced super-resolution generative adversarial networks (ESRGAN, Real-ESRGAN, etc.), shifted window transformers (SwinIR), and latent diffusion super-resolution (LDSR). Any of these models and/or architectures may be employed to align a resolution of one or more input frames with a resolution of media plane 104 (e.g., 16K x 16K). In some embodiments, content enhancement engine 730 may undergo an iterative refinement process to align one or more upscaled frames with an immersion threshold for a venue.

Alternatively or additionally, content enhancement engine 730 may employ a tiled-based processing system to upscale one or more input frames. In some embodiments, a tile-based upscaling system may be used to address memory constraints and/or enable parallel processing. Content enhancement engine 730 may split an input frame into multiple tiles. In some embodiments, content enhancement engine 730 may split an input frame into overlapping tiles of adjustable sizes based on the content and/or the model being employed (e.g., “adaptive tiling”). For example, content enhancement engine 730 may analyze a complexity of the content to determine a tile size, with larger tiles being used for areas with lower complexity and smaller tiles for regions with finer details. In some embodiments, the overlap between tiles may also be determined in a dynamic fashion to ensure smoother blending during downstream processing.

Content enhancement engine 730 may also blend one or more boundary regions between adjacent tiles. In some embodiments, content enhancement engine 730 may employ one or more of models 756 to blend and/or regenerate overlapping regions between tiles. Content enhancement engine 730 may then reassemble the processed tiles into an aggregated high-resolution output. In some embodiments, content enhancement engine 730 may apply additional post-processing and inferences through one or more of models 756 to ensure global spatial consistency (e.g., in color, contrast, sharpness, and across visual artifacts).

Content enhancement engine 730 may also refine one or more frames until a pre-defined temporal coherence threshold across a sequence of frames (e.g., one or more frames that have been upscaled) is met. In some embodiments, content enhancement engine 730 may employ recurrent neural network models (“RNNs”) to track visual content between and across frames. RNNs may be used to encode temporal information within hidden states to identify predictable motion patterns. Alternatively or additionally, content enhancement engine 730 may employ temporal attention mechanisms to establish relationships between corresponding regions across frames (e.g., spacetime/spatiotemporal patches). When refining any given frame, content enhancement engine 730 may reference specific features from previous frames to maintain consistent appearance of any subjects, objects, or textures within the sequence. In some embodiments, content enhancement engine 730 may also employ temporal diffusion techniques, which involve calculating a frame difference-based temporal loss between adjacent frames. In such embodiments, content enhancement engine 730 may use the calculated frame difference-based temporal loss to guide the regeneration of the one or more frames. Alternatively or additionally, content enhancement engine 730 may estimate flow maps between adjacent frames and use the estimated flow information to guide the diffusion regeneration process.

Content enhancement engine 730 may also perform frame rate up-conversion on media content obtained or generated by experiential media adaptation platform 702. In some embodiments, content enhancement engine 730 may accomplish this by generating one or more interpolated frames between existing frames of media content (e.g., one or more temporal extension videos). In some embodiments, content enhancement engine 730 may generate one or more interpolated frames in a similar fashion as content generation engine 728. For example, content enhancement engine 730 may define one or more parameters for one or more of models 756 and one or more queries describing one or more target outputs for a set of interpolated frames (either individually or in aggregate) between video frames. For example, the one or more parameters may include a target frame rate (e.g., 60 fps, 120 fps, etc.). Content enhancement engine 730 may then calculate and generate a corresponding number of interpolated frames for the media content by querying MLP 706 with the query and the one or more parameters to produce the interpolated frames according to the one or more parameters and the query.

Composition engine 732 may perform various compositing operations to combine, integrate, and/or blend various visual content obtained or generated by experiential media adaptation platform 702, such as cinematic media content 736, one or more media frames of cinematic media content 736, data prepared by data preparation engine 716, content generated by content generation engine 728, and/or content enhanced by content enhancement engine 730. In some embodiments, composition engine 732 may compose one or more temporal extension videos generated by content generation engine 728 and/or content enhancement engine 730 to produce experiential media content 738 (or a near-final version of experiential media content 738). For example, composition engine 732 may employ techniques such as but not limited to alpha compositing, chroma keying, rotoscoping, digital matting, motion tracking, color correction, image transformation, and other compositing methods that will be apparent to those skilled in the relevant art(s) without departing from the spirit and scope of the present disclosure. Composition engine 732 may also employ various image processing techniques, such as color grading, tone mapping, dynamic range compression, filtering operations, or image transformations.

Alternatively or additionally, composition engine 732 may leverage machine learning approaches, such as machine learning-aided rotoscoping, intelligent keying, context-aware filling, and/or style transferring to obtain experiential media content 738.

User interface 746 may be configured to render content including unimodal responses, multimodal responses, or other content for audible or visual presentation to a user of client device 704 using one or more user interface output devices. For example, client device 704 may include a display or projector that enables content to be provided for visual presentation to a user via client device 704. Alternatively or additionally, client device 704 may include one or more speakers that enable content to be provided for audible presentation to a user via client device 704.

User input engine 748 may detect user input provided by a user of client device 704 using one or more user interface input devices. For example, client device 704 may include one or more microphones that capture audio data, such as audio data corresponding to spoken utterances of the user or other sounds in an environment surrounding client device 1704. Alternatively or additionally, client device 704 may include one or more vision components (e.g., a camera) that may capture vision data corresponding to images and/or movements (e.g., gestures) detected in a field of view of one or more of the vision components. Alternatively or additionally, client device 704 may include one or more touch sensitive components including, but not limited to, a keyboard and mouse, a stylus, a touch screen, a touch panel, and physical buttons configured to capture signals corresponding to touch input directed towards client device 704.

Application engine 750 may execute one or more software applications on client device 704. In some aspects, application engine 750 may submit one or more queries (e.g., user query 752) to experiential media adaptation platform 702. Application engine

750 may then receive unimodal, multimodal, or other responses from experiential media adaptation platform 702 in response to a natural language query, which may then be rendered onto user interface 746 (e.g., audibly and/or visually). Application engine 750 may execute one or more software applications that are separate from an operating system of the client device 704 or may alternatively be implemented directly by the operating system of client device 704. For example, the application engine 750 may execute one or more software applications via a web browser or assistant.

User query 752 may represent an input provided by a user of client device 704 and may be detected via user input engine 748. For example, user query 752 may include a question or task by a user regarding one or more of media frames 712 and/or archival content 714, such as generating inferred content from a frame. In some aspects, user query 752 may be a typed query that is typed via a physical or virtual keyboard, a suggested query that is selected via a touch screen or a mouse of client device 704, a spoken voice query that is detected via a microphone of client device 704 (or directed to an voice assistant running at client device 704), or an image or video query that is based on vision data captured by a vision component of client device 704 and/or uploaded to client device 704.

In some embodiments, user query 752 may be converted to a natural language based input and/or a multimodal input to be submitted to experiential media adaptation platform 702. Alternatively or additionally, user query 752 may be sourced via image processing techniques utilizing, for example, object detection models, captioning models, or the like. In some embodiments, user query 752 may be a prompt for content that is formulated based on user input provided by a user of client device 704 and detected via user input engine 748. For example, the prompt can be a typed prompt that is typed via a physical or virtual keyboard, a suggested prompt that is selected via a touch screen or a mouse of client device 704, a spoken prompt that is detected via a microphone of client device 704, or an image or video prompt based on data captured by a vision component of client device 704 and/or uploaded to client device 704.

client memory 754 may store conversation and/or session data by a user with experiential media adaptation platform 702. Client memory 754 may also store user interaction data about current or recent interactions between a user or multiple users and client device 704. In some embodiments, client memory 754 may also store location data about current or recent locations of client device 704 or a geographical region associated with a user of client device 704. Client memory 754 may also store user attribute data, user preference data, a user profile, or various configurations relating to client device 704 or a user of client device 704 (e.g. parameters for one or more machine learning models). In some embodiments, the data stored in client memory 754 may be communicated partially or entirely to experiential media adaptation platform 702 (e.g., to produce higher quality outputs).

### EXEMPLARY PIPELINES THAT CAN BE INCORPORATED WITHIN THE EXPERIENTIAL MEDIA ADAPTATION PLATFORM

FIG. 8 illustrates an example training pipeline 800 for training object models, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 8, as will be understood by a person of ordinary skill in the art. Training pipeline 800 shall be described with reference to FIG. 7. However, training pipeline 800 is not limited to those example embodiments.

Training pipeline 800 illustrates the process of training object models 808 for various content generation and/or content enhancement functionality. In some embodiments, training pipeline 800 may operate partially or entirely within experiential media adaptation platform 702. Alternatively or additionally, in some embodiments, training pipeline 800 may operate partially or entirely at third party servers. In some embodiments, any operation within preprocessing stage 804, validation stage 810, and/or model deployment stage 814 may be accessible though API calls within experiential media adaptation platform 702. In such embodiments, any operation within preprocessing

As depicted in FIG. 8, example training pipeline 800 may include a data collection stage 802, a preprocessing stage 804, a validation stage 810, and a model deployment stage 814. In some embodiments, example training pipeline 800 may be implemented in a machine learning platform (e.g., MLP 706) and/or a model training engine (e.g., model training engine 726). In data collection stage 802, archival material 816 and source material 818 may be obtained. For example, experiential media adaptation platform 702 may receive media frames of source material 818 and archival content 816 collected by data collection platform 710. Source material 818 may be an example of media frames 712 and include final video footage, raw source images, and/or raw video footage, as well as one or more portions, sections, or subsections thereof. Archival content 816 may be an example of archival content 714 and include supplementary material to the image frames of the raw source footage, such as but not limited to behind-the-scenes material, concept art, storyboards, reference images, and the like. In some embodiments, data collection stage 802 may involve a fully automated data collection pipeline. The pipeline may employ various technological approaches such as, but not limited to, web scraping, data mining algorithms, semantic analysis, and natural language processing on online data related to, providers of, and/or content derived from archival material 816 or source material 818.

In preprocessing stage 804, data from data collection stage 802 may be processed and organized for training object models 808. Preprocessing stage 804 may include a computer vision processing stage 824, a classification stage 826, and an organization stage 828. In computer vision processing stage 824, one or more objects may be extracted from source material 818. In some embodiments, image segments and/or segmentation masks may be obtained for unique objects within source material 818. For example, computer vision engine 722 may employ one or more of the segmentation methods described above to obtain image segments for training objects 806. In classification stage 826, one or more image segments or segmentation masks may be classified into character objects 820 and environment objects 822. As a non-limiting example, experiential media adaptation platform 702 may classify a person and a specific character as character objects 820, and experiential media adaptation platform 702 may classify a cloud and a

1. patch of grass as environment objects 822 using one or more of models 756. Alternatively or additionally, classification stage 826 may be performed using one or more human-in-the-loop configurations, where experiential media adaptation platform 702 receives one or more of classified character objects 820 and/or environment objects 822 from client device 704. In organization stage 828, classified image segments and/or segmentation masks may be grouped into separate datasets for each of training objects 806 for training object-specific machine learning models (e.g., object models 808).

In validation stage 810, data processed in preprocessing stage 804 may be leveraged to train and/or fine-tune object models 808 on individual training objects of training objects 806 identified from source material 818. In validation stage, various training strategies and loss functions such as reconstruction loss 830, perceptual loss 832, and adversarial loss 834 may be employed to calculate model updates 812 for object models 808. Reconstruction loss 830 may measure the difference between a predicted noise (e.g., what a model thinks was added) and the actual noise that was added to an image at a given time step. In some embodiments, reconstruction loss 830 may be implemented using mean squared error loss (MSE). Perceptual loss 832 may measure the difference between high-level features in generated images and actual images from a target training domain. For example, a fully denoised output from object models 808 may be compared against examples of the corresponding training object to calculate perceptual loss 832. Adversarial loss 834 may involve training a separate classifier model to distinguish between generated content and training data obtained from source material 818. The separate classifier model may then measure how well generated content matches a statistical distribution of the original training content. As adversarial loss 834 is minimized, the content generated by object models 808 may become more faithful to the original training content and/or other training objectives (e.g., immersion threshold(s) for a venue). During the training process, model updates 812 may be made to object models 808 using various backpropagation or optimization algorithms, such as, but not limited to, stochastic gradient descent or Adam. After an iterative process, object models 808 may be deployed in model deployment stage 814. In some embodiments, object models 808 may then be used for generating and/or enhancing various content for experiential media adaptation platform 702.

As with the examples described above, specific examples of training objects, preprocessing strategies, and validation strategies, have been described herein. However, these examples are not meant to be limiting nor meant to represent an exhaustive list of possible implementations. The scope of the technology disclosed herein is not limited to only these examples, and other implementations are contemplated as appreciated by one skilled in the art.

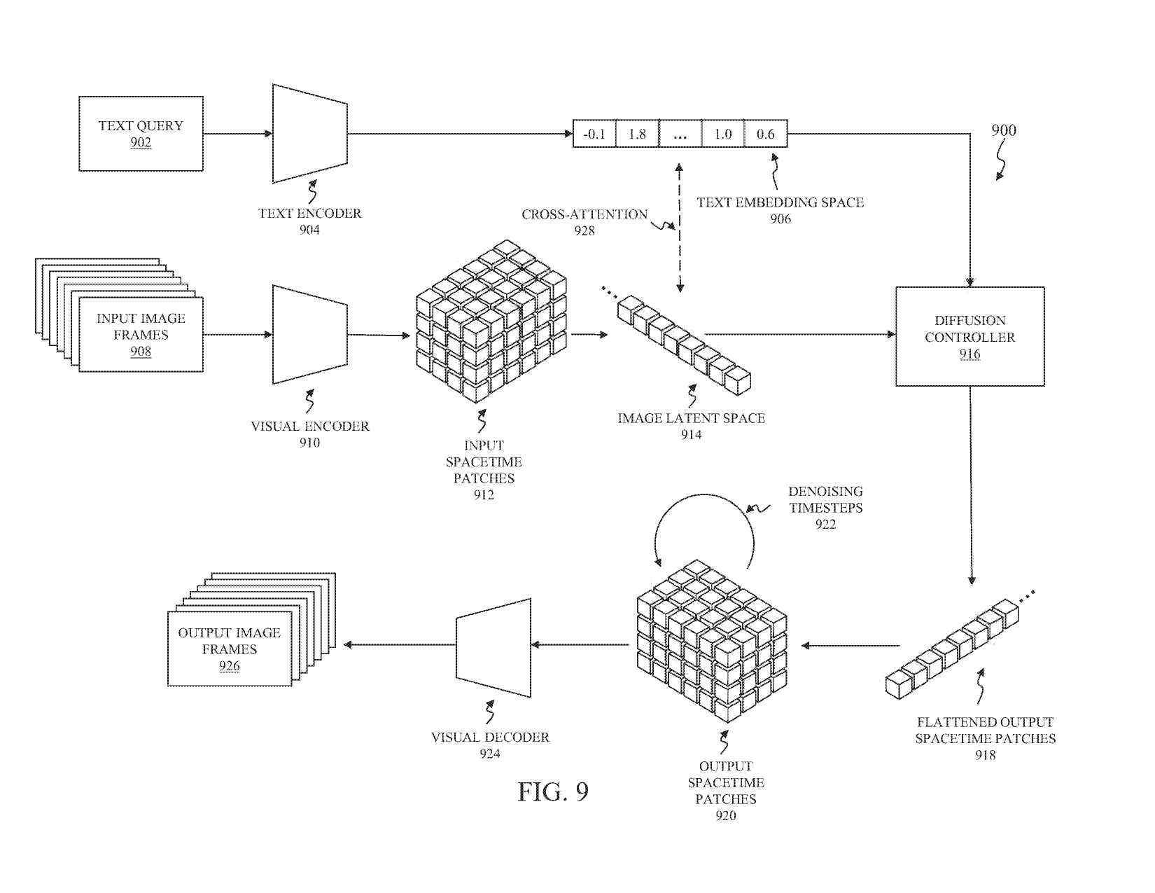

FIG. 9 illustrates an example inference pipeline 900 for generating output image frames, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 9, as will be understood by a person of ordinary skill in the art. Inference pipeline 900 shall be described with reference to FIG. 7-8. However, inference pipeline 900 is not limited to those example embodiments.

1. executing on MLP 706, such as but not limited to standard diffusion or latent diffusion models, rectified flow models, vision transformers, multimodal diffusion transformers, video vision transformers, and other multimodal models capable of processing diverse input modalities. In some embodiments, text encoder 904, visual encoder, 910, diffusion controller 916, and visual decoder 924 may be part of the same model (e.g., model 756.n). Alternatively or additionally, any combination or subcombination of text encoder 904, visual encoder, 910, diffusion controller 916, and visual decoder 924 may be part of separate models.

In some embodiments, text embedding space 906, image latent space 914, cross-attention 928, and any self-attention values may be passed to diffusion controller 916 to guide the denoising process (e.g., “reverse diffusion”). Alternatively or additionally, one or more control networks may be passed into diffusion controller 916. In some embodiments, flattened output spacetime patches 918 may represent a starting state of a final output (e.g., output image frames 926). For example, flattened output spacetime patches 918 may be initialized as pure noise, such as random Gaussian noise. Example inference pipeline 900 may proceed to perform one or more denoising timesteps 922 to

iteratively denoise output spacetime patches 918 (or flattened output spacetime patches 918). At each timestep of denoising timesteps 922, diffusion controller 916 may take text embedding space 906, image latent space 914, cross-attention 928, and any self-attention values as conditioning information to denoise output spacetime patches 920 towards the one or more target outputs. Alternatively or additionally, diffusion controller 916 may also take one or more control networks as conditioning information. After performing one or more denoising timesteps 922, visual decoder 924 may decode a denoised state of output spacetime patches 920 into one or more of output image frames 926.

As with the examples described above, specific examples of model architectures and conditioning strategies have been described herein. However, these examples are not meant to be limiting nor meant to represent an exhaustive list of possible implementations. The scope of the technology disclosed herein is not limited to only these examples, and other implementations are contemplated as appreciated by one skilled in the art.

### EXEMPLARY OPERATIONAL CONTROL FLOWS FOR THE EXPERIENTIAL MEDIA ADAPTATION PLATFORM

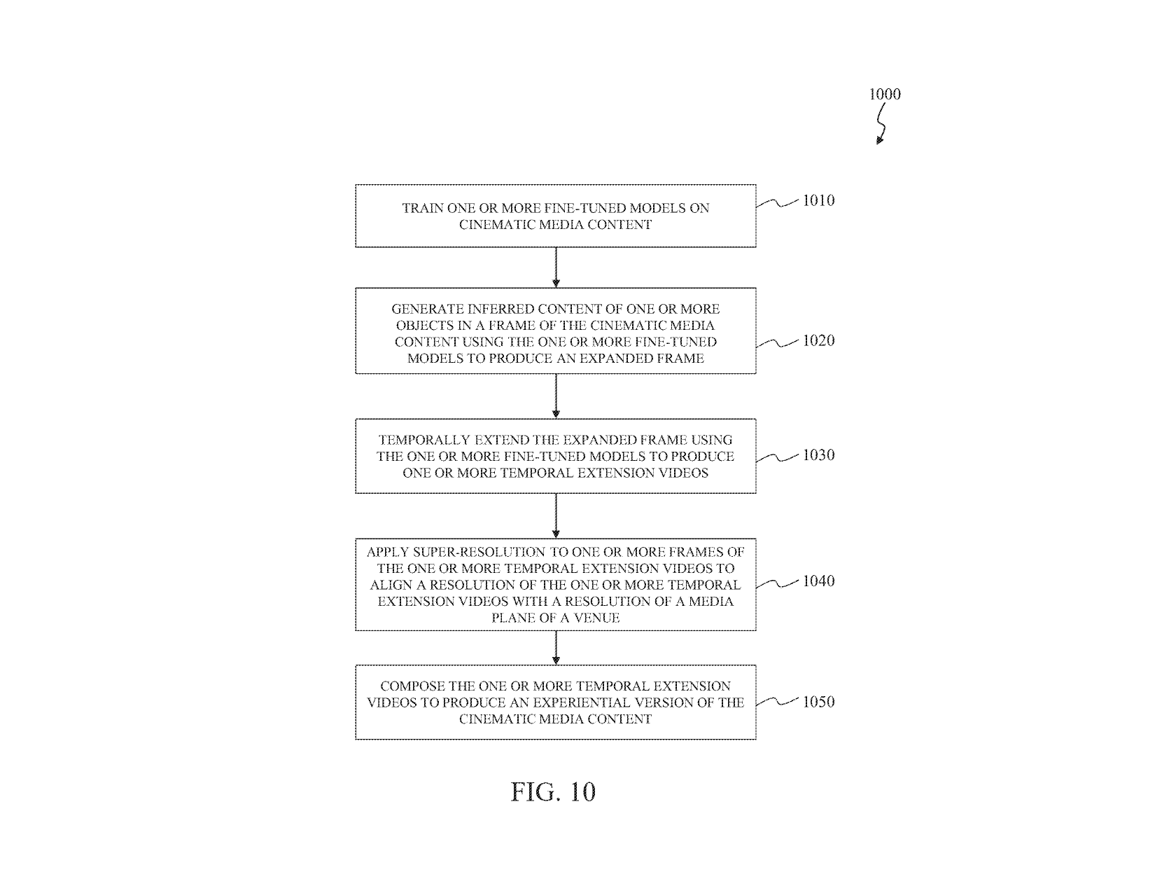

FIG. 10 illustrates an exemplary operational control flow 1000 for adapting cinematic media content to experiential media content, according to some embodiments. Exemplary operational control flow 1000 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art. Further, method 1000 may not include all the steps illustrated.

Exemplary operational control flow 1000 shall be described with reference to FIGS. 4-9. However, exemplary operational control flow 1000 is not limited to those example embodiments. One or more of the operations in the operational control flow depicted by FIG. 10 may be carried out by one or more entities, including, without limitation, experiential media content workstation 410, experiential media content workstation 612, experiential media adaptation platform 702, client device 704, MLP

706, modeling engine 758, other server or cloud-based server processing systems and/or one or more entities operating on behalf of or in cooperation with these or other entities. One or more of the operations in the operational control flow depicted by FIG. 10 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

At operation 1010, the operational control flow 1000 trains one or more fine-tuned models on cinematic media content. For example, experiential media adaptation platform 702 may employ model training engine 726 to train one or more models 756.a through 756.n on MLP 706 on a corresponding set of objects within cinematic media content 708. Cinematic media content 708 may be in a rectilinear format. Models 756.a through 756.n may be diffusion models, latent diffusion models, rectified flow models, vision transformers, multimodal diffusion transformers, or video vision transformers. In some embodiments, experiential media adaptation platform 702 may perform segmentation on cinematic media content 708, media frames 712, and/or archival content 714 to obtain image segments or segmentation masks for objects. Experiential media adaptation platform 702 may also annotate the image segments or segmentation masks with one or more descriptive tags. Experiential media adaptation platform 702 may then fine-tune one or more machine learning models using the annotated image segments or segmentation masks to obtain one or more machine learning models fine-tuned on one or more objects of cinematic media content 708. Alternatively or additionally, experiential media adaptation platform 702 may also perform classification on the image segments or segmentation masks to identify whether an object inside an image segment or segmentation mask is a character object or an environment object. Experiential media adaptation platform 702 may then train or fine-tune machine learning models on each identified character object and each identified environment object, at times using a different training or fine-tuning strategy (e.g., using more accurate, computationally intensive methods for character objects).

At operation 1020, operational control flow 1000 generates inferred content of one or more objects in a frame of the cinematic media content using the one or more fine-tuned models to produce an expanded frame. For example, experiential media adaptation platform 702 may generate inferred content from one or more objects in one or more frames of cinematic media content 736 in a cinematic resolution and/or field of view to obtain one or more expanded frames corresponding to experiential media content 738 in an experiential resolution and/or field of view using one or more fine-tuned models among models 756.a through 756.n. In some embodiments, experiential media adaptation platform 702 may perform object completion (e.g., generating inferred content for one or more objects that already exist within a frame being expanded). Experiential media adaptation platform 702 may also perform object generation (e.g., generating inferred content for one or more objects that do not exist within a frame being expanded, but exist elsewhere within cinematic media content 736). In some embodiments, experiential media adaptation platform 702 may leverage one or more control maps in performing object completion and/or object generation.

At operation 1030, the operational control flow 1000 temporally extends the expanded frame using the one or more fine-tuned models to produce a one or more temporal extension videos. For example, experiential media adaptation platform 702 may employ content generation engine 728 to generate one or more frames before or after an expanded frame using one or more models (or fine-tuned models) among models 756.a through 756.n, which may be diffusion models, latent diffusion models, rectified flow models, vision transformers, multimodal diffusion transformers, or video vision transformers.

At operation 1040, the operational control flow 1000 applies super-resolution to one or more frames of the one or more temporal extension videos to align a resolution of the one or more temporal extension videos with a resolution of media plane 104. For example, experiential media adaptation platform 702 may employ content enhancement engine 730 to apply super-resolution and/or any of the upscaling techniques described herein to one or more frames of a one or more temporal extension videos (e.g., experiential media content 738 or an intermediate state of experiential media content 738) from a lower, cinematic resolution to align with a higher, experiential resolution corresponding to a venue, such as a venue. The resolution of the venue may be a

resolution of a media plane that is part of the venue (e.g., media plane 104 of FIG. 5). The media plane may be a spherical and/or experiential display. For example, the resolution of the venue may be 8192 pixels x 8192 pixels or 16384 pixels by 16384 pixels. The resolution of the venue may also be a resolution of a VR environment.

At operation 1050, the operational control flow 1050 composes the one or more temporal extension videos to produce an experiential version of the cinematic media content. For example, experiential media adaptation platform 702 may employ composition engine 732 to apply any of the compositing techniques described herein to compose one or more one or more temporal extension videos together to produce experiential media content 738 (or a near-final stage of experiential media content 738). In some embodiments, composition engine 732 may compose any of cinematic media content 736, one or more media frames of cinematic media content 736, data prepared by data preparation engine 716, content generated by content generation engine 728, or content enhanced by content enhancement engine 730 together to obtain experiential media content 738.

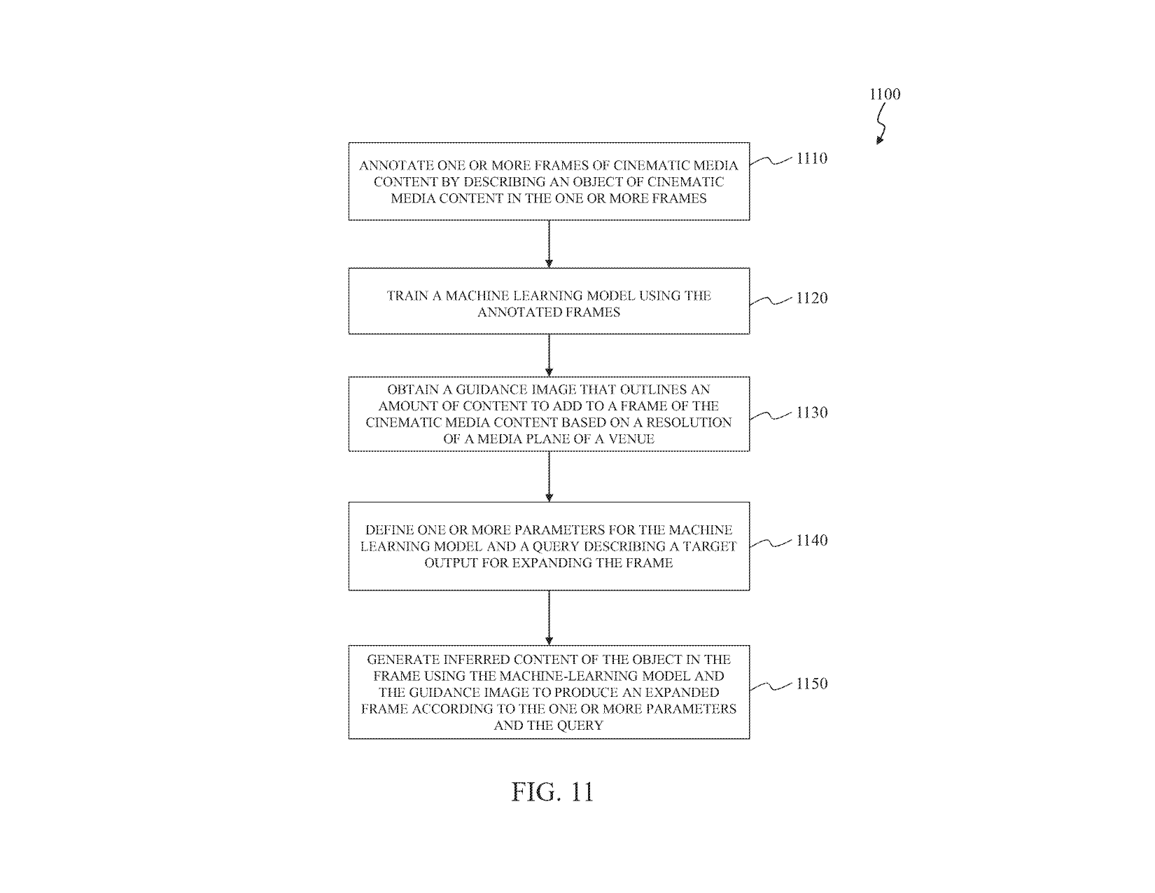

FIG. 11 illustrates an exemplary operational control flow 1100 for generating inferred object content, according to some embodiments. Exemplary operational control flow 1100 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 11, as will be understood by a person of ordinary skill in the art. Further, method 1100 may not include all the steps illustrated.

Exemplary operational control flow 1100 shall be described with reference to FIGS. 4-9. However, exemplary operational control flow 1100 is not limited to those example embodiments. One or more of the operations in the operational control flow depicted by FIG. 11 may be carried out by one or more entities, including, without limitation, experiential media content workstation 410, experiential media content workstation 612, experiential media adaptation platform 702, client device 704, MLP 706, modeling engine 758, other server or cloud-based server processing systems and/or one or more entities operating on behalf of or in cooperation with these or other entities.

One or more of the operations in the operational control flow depicted by FIG. 11 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

At operation 1110, the operational control flow 1100 annotates one or more frames of a cinematic media content by describing an object of the cinematic content in the one or more frames. For example, experiential media adaptation platform 702 may employ annotation engine 724 to obtain or generate descriptive tags for one or more frames of cinematic media content 736. In some embodiments, experiential media adaptation platform 702 may create a segmentation mask for one or more frames of cinematic media content 736 for identifying a target object within the one or more frames of cinematic media content 736. Alternatively or additionally, experiential media adaptation platform 702 may leverage one or more of the various segmentation techniques described herein to obtain one or more image segments or segmentation masks (which may also be image frames). These frames may be annotated by annotation engine 724 to describe various aspects of the object within the one or more frames, such as an action, an appearance, a style, or other attribute of the object. These annotated frames may then be organized by object and stored as datasets.

At operation 1120, the operational control flow 1100 trains the one or more machine learning models using the annotated frames. For example, experiential media adaptation platform 702 may employ model training engine 726 to train one or more models 756 on one or more frames annotated by annotation engine 724. In some embodiments, model training engine 726 may obtain a pre-trained machine learning model or partially trained machine learning model and fine-tune the pre-trained machine learning model or partially trained machine learning model, using the annotated frames as ground truth for optimization objectives.

At operation 1130, the operational control flow 1100 obtains a guidance image that outlines an amount of content to add to one or more frames of the cinematic media

content based on a resolution of media plane 104. For example, experiential media adaptation platform 702 may employ content generation engine 728 and/or modeling engine 758 to generate a guidance image to use as conditioning information for object completion or object generation. In some embodiments, the one or more guidance images may not be more than image, such as multiple images (e.g., “guidance images”) or a sequence of images (e.g., a “guidance video”). In some embodiments, the one or more guidance images may be in a lower resolution than the scaled frame. For example, the portions of the one or more guidance images surrounding the scaled frame may be captured at the lower resolution (e.g., using a previz feature of modeling engine 758). The resolution of the venue may be a resolution of a media plane that is part of the venue (e.g., media plane 104 of FIG. 5). The media plane may be a spherical and/or experiential display. For example, the resolution of the venue may be 8192 pixels x 8192 pixels or 16384 pixels by 16384 pixels. The resolution of the venue may also be a resolution of a VR environment.

At operation 1140, the operational control flow 1100 defines one or more parameters for the machine learning model and one or more queries describing one or more target outputs for expanding the frame. For example, experiential media adaptation platform 702 may define one or more of model parameters 744 and one or more of prompts 742 describing a one or more target outputs for a frame of experiential media content 738. In some embodiments, model parameters 744 may specify a particular CFG scale, seed values, a number of sampling steps, input/output resolution specifications, a sampler type, a frame rate, motion smoothness, target video durations, and/or temporal consistency weights. In some embodiments, prompts 742 may include positive prompts that describe desired elements to include in the generated output, negative prompts that specify elements to exclude, and prompt weighting that determines the relative importance of different elements within the prompt. Prompts 742 may also specify visual elements, styles, lighting conditions, composition elements, motion characteristics, transitions between scenes, camera movements, and temporal developments in the content.

At operation 1150, the operational control flow 1100 generates inferred content of the object in the one or more frames using the machine-learning model and the one or more guidance images to produce the expanded frame according to the one or more

parameters and the query. For example, experiential media adaptation platform 702 may employ content generation engine 728 to query MLP 706 with the one or more defined prompts from prompts 742, the one or more defined model parameters from model parameters 744, and the obtained guidance image to produce an expanded and/or result frame of experiential media content 738. Experiential media adaptation platform 702 may perform any number of iterations of object completion or object generation until a target expanded frame of experiential media content 738 is obtained (e.g., until the expanded frame meets an immersion threshold for a venue and/or an immersion threshold for a media plane of a venue). In some embodiments, experiential media adaptation platform 702 may leverage one or more control maps in performing object completion and/or object generation.

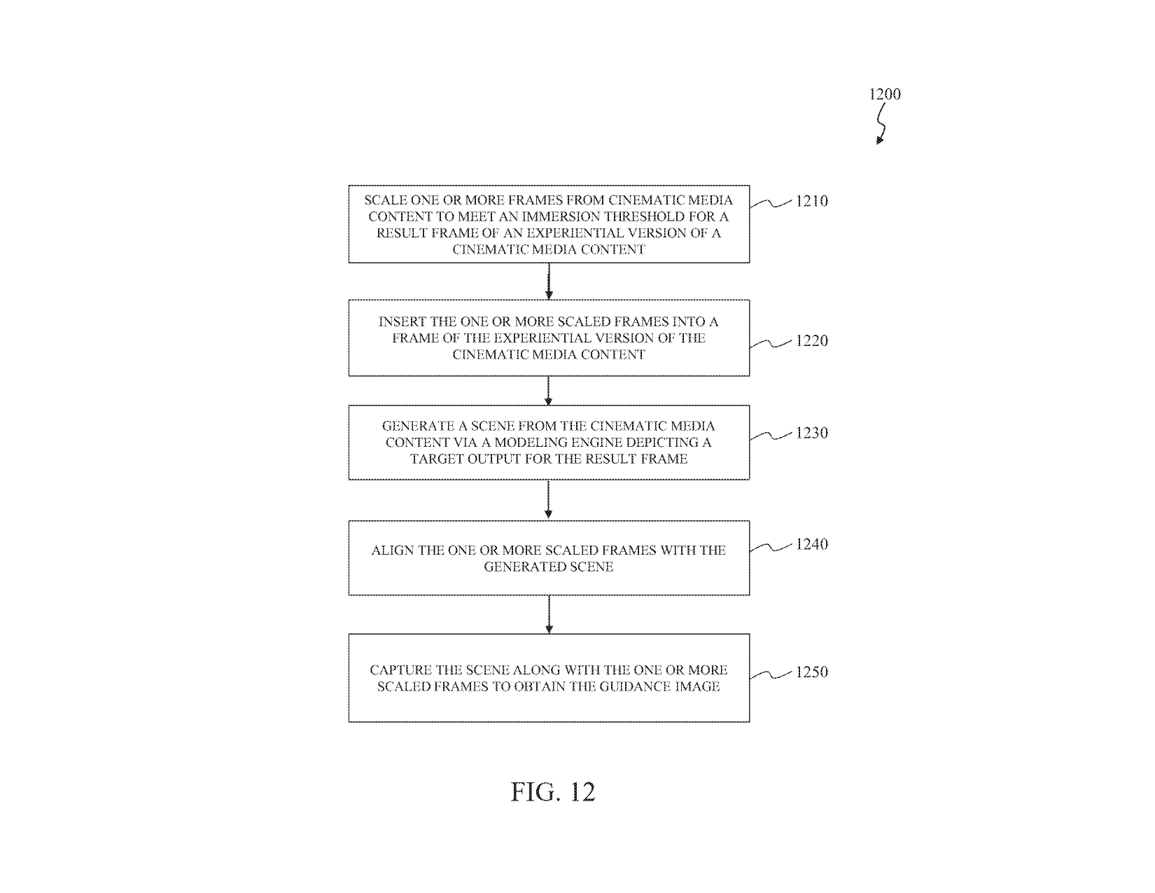

FIG. 12 illustrates an exemplary operational control flow 1200 for generating a guidance image, according to some embodiments. Exemplary operational control flow 1200 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 12, as will be understood by a person of ordinary skill in the art. Further, method 1200 may not include all the steps illustrated.

Exemplary operational control flow 1200 shall be described with reference to FIGS. 4-9. However, exemplary operational control flow 1200 is not limited to those example embodiments. One or more of the operations in the operational control flow depicted by FIG. 12 may be carried out by one or more entities, including, without limitation, experiential media content workstation 410, experiential media content workstation 612, experiential media adaptation platform 702, client device 704, MLP 706, modeling engine 758, other server or cloud-based server processing systems and/or one or more entities operating on behalf of or in cooperation with these or other entities. One or more of the operations in the operational control flow depicted by FIG. 12 may also or instead be carried out by one or more servers of an enterprise network and/or a cloud computing network and accessed via a client computer system that is connected thereto. Any such entity may embody a computing system, such as a programmed

processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

At operation 1210, the operational control flow 1200 scales one or more frames from a cinematic media content to meet an immersion threshold for a result frame of an experiential version of a cinematic media content. For example, experiential media adaptation platform 702 may employ content generation engine 728 to scale a frame from cinematic media content 736 to meet an immersion threshold for an expanded frame and/or result frame of experiential media content 738. An immersion threshold may refer to any perceptual loss function or heuristic that can guide content scaling and/or post-processing operations to align a piece of media with real-world proportions and spatial relationships. These one or more immersion thresholds may quantify a degree to which visual content (e.g., cinematic media content 736 or one or more frames of cinematic media content 736) should be adjusted to generate resulting media that creates immersion and matches a natural scale with the real-world (e.g., media that has high data fidelity with respect to the real-world). In some embodiments, immersion threshold(s) may include one or more perceptual factors including, but not limited to, subject/object size relativity, spatial depth cues, perspective accuracy, and human anthropometric measurements.

At operation 1220, the operational control flow 1200 inserts the one or more scaled frames into a frame of the experiential version of the cinematic media content. For example, experiential media adaptation platform 702 may insert the scaled frame in a frame of experiential media content 738 (or an intermediate stage of experiential media content 738).

At operation 1230, the operational control flow 1200 generates a scene from the cinematic media content via a modeling engine depicting a one or more target outputs for the result frame. For example, experiential media adaptation platform 702 may employ modeling engine 758 to generate a scene corresponding to the scaled frame. The generated scene in modeling engine 758 may depict a one or more target outputs for the corresponding result frame of experiential media content 738.

At operation 1240, the operational control flow 1200 aligns the one or more scaled frames with the generated scene. For example, experiential media adaptation platform 702 may then align the scaled frame with the generated scene. In some embodiments, experiential media adaptation platform 702 may accomplish this by positioning a virtual camera object until a field of view of the virtual camera object includes the scaled frame at a target location within the scene.

At operation 1250, the operational control flow 1200 captures the scene along with the one or more scaled frames to obtain the one or more guidance images. For example, experiential media adaptation platform 702 may then obtain a guidance image by capturing the generated scene along with the scaled frame. In some embodiments, the one or more guidance images may be in a lower resolution than the scaled frame. For example, the portions of the one or more guidance images surrounding the scaled frame may be captured at the lower resolution (e.g., using a previz feature of modeling engine 758). Alternatively or additionally, the scene may be captured or rendered at the lower resolution, and the one or more guidance images may be obtained by re-inserting and/or aligning the scaled frame (at an original resolution) onto the captured scene.

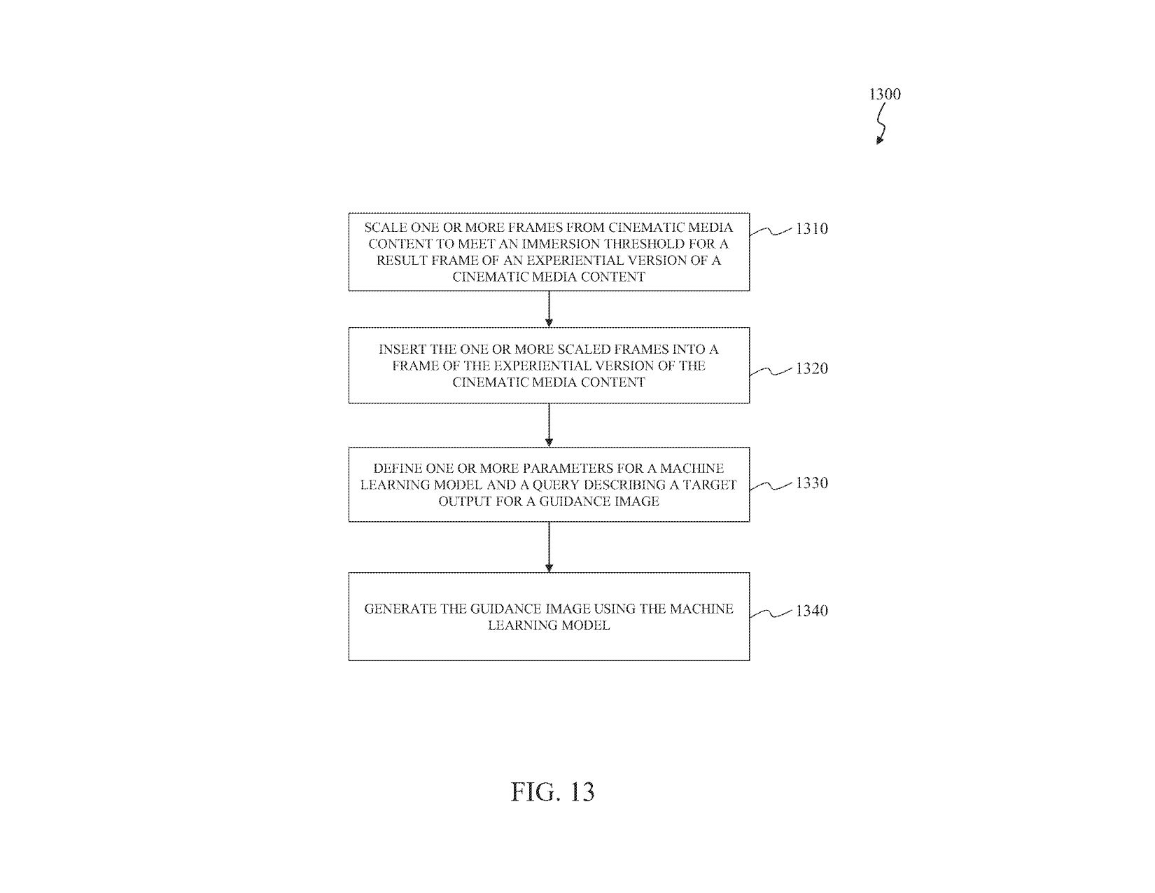

FIG. 13 illustrates another exemplary operational control flow 1300 for generating a guidance image, according to some embodiments. Exemplary operational control flow 1300 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 13, as will be understood by a person of ordinary skill in the art. Further, method 1300 may not include all the steps illustrated.

Exemplary operational control flow 1300 shall be described with reference to FIGS. 4-9. However, exemplary operational control flow 1300 is not limited to those example embodiments. One or more of the operations in the operational control flow depicted by FIG. 13 may be carried out by one or more entities, including, without limitation, experiential media content workstation 410, experiential media content workstation 612, experiential media adaptation platform 702, client device 704, MLP 706, modeling engine 758, other server or cloud-based server processing systems and/or

one or more entities operating on behalf of or in cooperation with these or other entities. One or more of the operations in the operational control flow depicted by FIG. 13 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

At operation 1310, the operational control flow 1300 scales one or more frames from a cinematic media content to meet an immersion threshold for a result frame of an experiential version of a cinematic media content. For example, experiential media adaptation platform 702 may employ content generation engine 728 to scale a frame from cinematic media content 736 to meet an immersion threshold for an expanded frame and/or result frame of experiential media content 738. An immersion threshold may refer to any perceptual loss function or heuristic that can guide content scaling and/or post-processing operations to align a piece of media with real-world proportions and spatial relationships. These one or more immersion thresholds may quantify a degree to which visual content (e.g., cinematic media content 736 or one or more frames of cinematic media content 736) should be adjusted to generate resulting media that creates immersion and matches a natural scale with the real-world (e.g., media that has high data fidelity with respect to the real-world). In some embodiments, immersion threshold(s) may include one or more perceptual factors including, but not limited to, subject/object size relativity, spatial depth cues, perspective accuracy, and human anthropometric measurements.

At operation 1320, the operational control flow 1300 inserts the one or more scaled frames into a frame of the experiential version of the cinematic media content. For example, experiential media adaptation platform 702 may insert the scaled frame in a frame of experiential media content 738 (or an intermediate stage of experiential media content 738).

At operation 1330, the operational control flow 1300 defines one or more parameters for the one or more machine learning models and one or more queries

describing a one or more target outputs for a guidance image. For example, experiential media adaptation platform 702 may define one or more parameters of model parameters 744 for one or more of models 756 and a prompt from prompts 742 describing a one or more target outputs for a guidance image. In some embodiments, model parameters 744 may specify a particular output resolution, for example a lower resolution than the one or more scaled frames. Model parameters 744 may also specify a sampler type, a frame rate, motion smoothness, target video durations, and temporal consistency weights. In some embodiments, prompts 742 may include positive prompts that describe desired elements to include in the generated output, negative prompts that specify elements to exclude, and prompt weighting that determines the relative importance of different elements within the prompt. Prompts 742 may also specify visual elements, styles, lighting conditions, composition elements, motion characteristics, transitions between scenes, camera movements, and temporal developments in the content.

At operation 1340, the operational control flow 1300 generates the one or more guidance images using the machine learning model. For example, experiential media adaptation platform 702 may generate the one or more guidance images by querying MLP 706 with one or more defined prompts of prompts 742 and one or more defined parameters of model parameters of model parameters 744 to produce a guidance image according to the one or more parameters and the prompt(s). In some embodiments, experiential media adaptation platform 702 may leverage one or more control maps in generating the one or more guidance images.

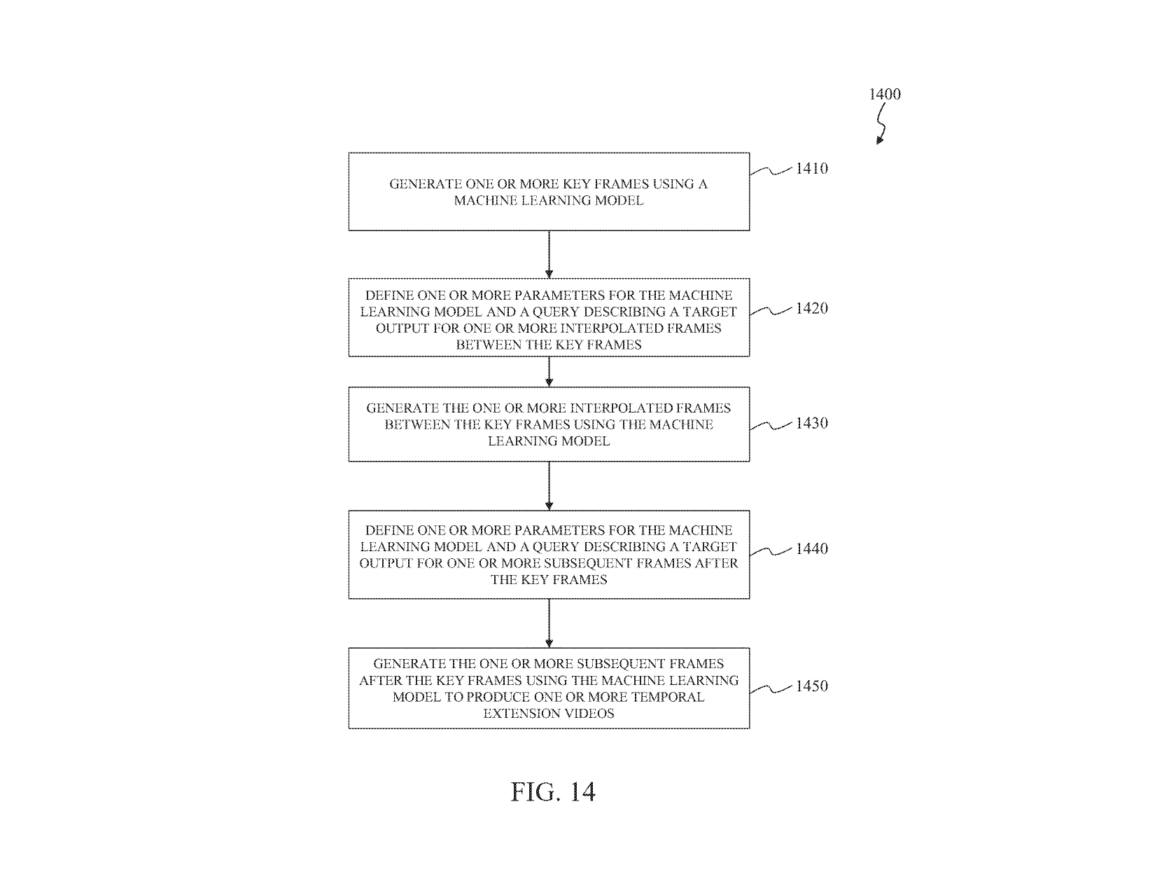

FIG. 14 illustrates an exemplary operational control flow 1400 for generating a one or more temporal extension videos, according to some embodiments. Exemplary operational control flow 1400 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 14, as will be understood by a person of ordinary skill in the art. Further, method 1400 may not include all the steps illustrated.

Exemplary operational control flow 1400 shall be described with reference to FIGS. 4-9. However, exemplary operational control flow 1400 is not limited to those

example embodiments. One or more of the operations in the operational control flow depicted by FIG. 14 may be carried out by one or more entities, including, without limitation, experiential media content workstation 410, experiential media content workstation 612, experiential media adaptation platform 702, client device 704, MLP 706, modeling engine 758, other server or cloud-based server processing systems and/or one or more entities operating on behalf of or in cooperation with these or other entities. One or more of the operations in the operational control flow depicted by FIG. 14 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

At operation 1410, the operational control flow 1400 generates one or more key frames using the one or more machine learning models. For example, experiential media adaptation platform 702 may employ content generation engine 728 to generate one or more expanded frames and/or result frames of experiential media content 738, which may serve as one or more key frames for a video extension process, using one or more models 756 executing on MLP 706. In some embodiments, the one or more key frames may represent key checkpoints in an action sequence of one or more objects.

At operation 1420, the operational control flow 1400 defines one or more parameters for the machine learning model and one or more queries describing a one or more target outputs for one or more interpolated frames between the key frames. For example, experiential media adaptation platform 702 may define one or more parameters of model parameters 744 for one or more of models 756 and a prompt from prompts 742 describing one or more target outputs for one or more interpolated frames between the one or more key frames of experiential media content 738. For example, the one or more parameters of model parameters 744 may include a number of interpolated frames to generate and/or a target duration.

At operation 1430, the operational control flow 1400 generates the one or more interpolated frames between the key frames using the machine learning model. For

example, experiential media adaptation platform 702 may employ content generation engine 728 to generate the set of interpolated frames by querying MLP 706 with the defined prompt of prompts 742 and the one or more defined parameters of model parameters 744 to produce the interpolated frames according to the one or more parameters and the query. Experiential media adaptation platform 702 may repeat a similar process for each of the key frames obtained or generate multiple sets of interpolated frames through one query. In some embodiments, experiential media adaptation platform 702 may leverage one or more control maps in generating the one or more interpolated frames.

At operation 1440, the operational control flow 1400 defines one or more parameters for the machine learning and one or more queries describing one or more target outputs for one or more subsequent frames after the key frames. For example, experiential media adaptation platform 702 may define one or more parameters of model parameters 744 for one or more of models 756 and a prompt from prompts 742 describing one or more target outputs for one or more subsequent frames after the one or more key frames of experiential media content 738. For example, the one or more parameters of model parameters 744 may include a number of subsequent frames to generate and/or a target duration.

At operation 1450, the operational control flow 1400 generates the one or more subsequent frames using the machine learning model to produce one or more temporal extension videos. For example, experiential media adaptation platform 702 may employ content generation engine 728 to generate the set of subsequent frames by querying MLP 706 with the defined prompt of prompts 742 and the one or more defined parameters of model parameters 744 to produce the subsequent frames according to the one or more parameters and the query. The set of final generated frames may compose one or more temporal extension videos. In some embodiments, experiential media adaptation platform 702 may query MLP 706 with the relevant key frames (e.g., a final key frame) to obtain the subsequent frames. Experiential media adaptation platform 702 may also query MLP 706 with the current set of frames for a sequence (e.g., the one or more key frames and/or one or more interpolated frames) to obtain subsequent frames for the sequence. In some embodiments, experiential media adaptation platform 702 may leverage one or more control maps in generating the one or more subsequent frames.

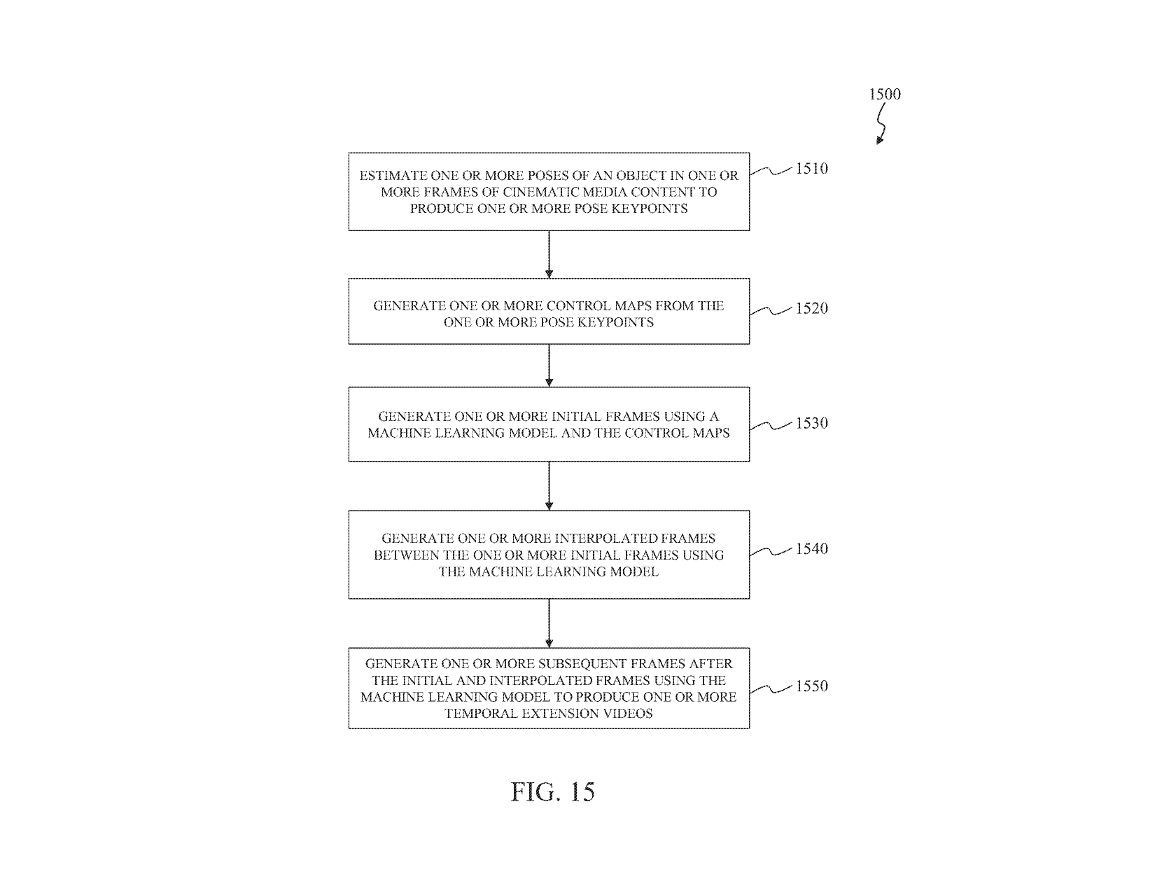

FIG. 15 illustrates another exemplary operational control flow 1500 for generating one or more temporal extension videos, according to some embodiments. Exemplary operational control flow 1500 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 15, as will be understood by a person of ordinary skill in the art. Further, method 1500 may not include all the steps illustrated.

Exemplary operational control flow 1500 shall be described with reference to FIGS. 4-9. However, exemplary operational control flow 1500 is not limited to those example embodiments. One or more of the operations in the operational control flow depicted by FIG. 15 may be carried out by one or more entities, including, without limitation, experiential media content workstation 410, experiential media content workstation 612, experiential media adaptation platform 702, client device 704, MLP 706, modeling engine 758, other server or cloud-based server processing systems and/or one or more entities operating on behalf of or in cooperation with these or other entities. One or more of the operations in the operational control flow depicted by FIG. 15 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

At operation 1510, the operational control flow 1500 estimates one or more poses of an object in one or more frames of cinematic media content to produce one or more pose keypoints. For example, experiential media adaptation platform 702 may employ content enhancement engine 730 to perform pose estimation techniques to obtain one or more pose keypoints on image segments for an object. These techniques may include, but are not limited to OpenPose, MediaPipe Pose, DWPose, MMPose, YOLO-Pose, HRNet, PoseNet, AlphaPose, and ViTPose. To obtain image segments for an object, experiential media adaptation platform 702 may leverage one or more of the various segmentation techniques described herein.

At operation 1520, the operational control flow 1500 generates one or more control maps from the one or more pose keypoints. For example, experiential media adaptation platform 702 may employ content generation engine 728 to generate corresponding sets of control maps from the one or more pose keypoints for generating one or more key frames. In some embodiments, the one or more pose keypoints may be adjusted to reflect a target pose for a key frame. In some embodiments, the one or more pose keypoints may also need to be converted to a different pose estimation format (e.g., one such as OpenPose that is compatible with ControlNet or another spatial conditioning network).

At operation 1530, the operational control flow 1500 generates one or more initial frames using the one or more machine learning models and the control maps. For example, experiential media adaptation platform 702 may employ content generation engine 728 to generate the one or more key frames with one or more of models 756 and the control map (e.g., via one or more queries describing one or more target outputs for one or more initial frames for experiential media content 738 and one or more parameters to be transmitted to MLP 706 executing models 756).

At operation 1540, the operational control flow 1500 generates one or more interpolated frames between the one or more initial frames using the machine learning model. For example, experiential media adaptation platform 702 may define one or more parameters of model parameters 744 for one or more of models 756 and a prompt from prompts 742 describing one or more target outputs for one or more interpolated frames between the one or more initial frames of experiential media content 738, including, for example, a number of interpolated frames to generate and/or a target duration. Experiential media adaptation platform 702 may then employ content generation engine 728 to generate the set of interpolated frames by querying MLP 706 with the defined prompt of prompts 742 and the one or more defined parameters of model parameters 744 to produce the interpolated frames according to the one or more parameters and the query. Experiential media adaptation platform 702 may repeat a similar process for each of the key frames obtained or generate multiple sets of interpolated frames through one query.

At operation 1550, the operational control flow 1500 generates one or more subsequent frames after the initial and interpolated frames using the machine learning model to produce one or more temporal extension videos. For example, experiential media adaptation platform 702 may define one or more parameters of model parameters 744 for one or more of models 756 and a prompt from prompts 742 describing one or more target outputs for one or more subsequent frames after the one or more key frames of experiential media content 738, including, for example, a number of subsequent frames to generate and/or a target duration. Experiential media adaptation platform 702 may then employ content generation engine 728 to generate the set of subsequent frames by querying MLP 706 with the defined prompt of prompts 742 and the one or more defined parameters of model parameters 744 to produce the subsequent frames according to the one or more parameters and the query. The set of final generated frames may compose one or more temporal extension videos. In some embodiments, experiential media adaptation platform 702 may query MLP 706 with the relevant key frames (e.g., a final key frame) to obtain the subsequent frames. Experiential media adaptation platform 702 may also query MLP 706 with the current set of frames for a sequence (e.g., the one or more key frames and/or one or more interpolated frames) to obtain subsequent frames for the sequence.

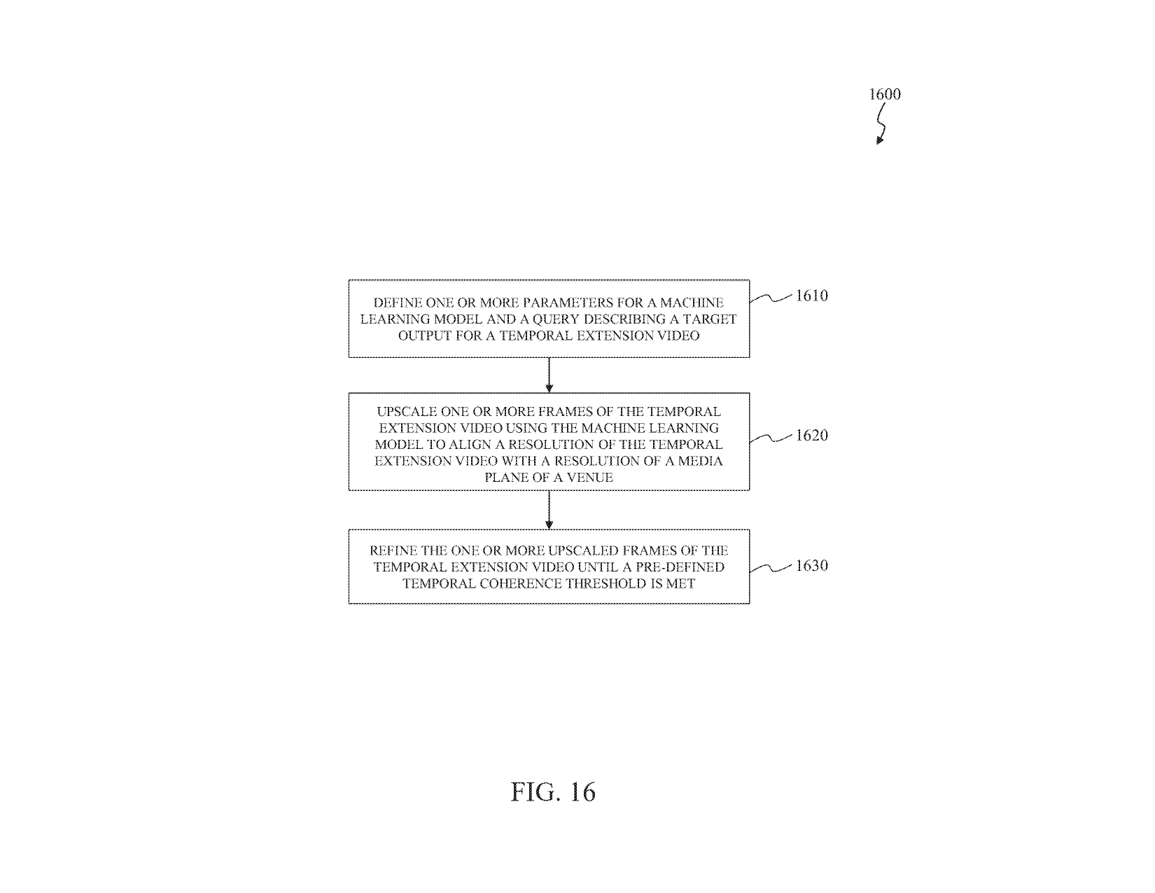

FIG. 16 illustrates an exemplary operational control flow 1600 for upscaling an experiential media, according to some embodiments. Exemplary operational control flow 1600 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 16, as will be understood by a person of ordinary skill in the art. Further, method 1600 may not include all the steps illustrated.

Exemplary operational control flow 1600 shall be described with reference to FIGS. 4-9. However, exemplary operational control flow 1600 is not limited to those example embodiments. One or more of the operations in the operational control flow depicted by FIG. 16 may be carried out by one or more entities, including, without limitation, experiential media content workstation 410, experiential media content

workstation 612, experiential media adaptation platform 702, client device 704, MLP 706, modeling engine 758, other server or cloud-based server processing systems and/or one or more entities operating on behalf of or in cooperation with these or other entities. One or more of the operations in the operational control flow depicted by FIG. 16 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

At operation 1610, the operational control flow 1600 defines one or more parameters for the one or more machine learning models and one or more queries describing one or more target outputs for one or more temporal extension videos. For example, experiential media adaptation platform 702 may define one or more parameters of model parameters 744 for one or more of models 756 and a prompt from prompts 742 describing one or more target outputs for upscaling one or more frames of experiential media content 738, including, for example, a classifier free guidance value, a number of iterations, a sampler type, a seed value, one or more target output resolutions, a generation style, and/or a model type.

At operation 1620, the operational control flow 1600 upscales one or more frames of the one or more temporal extension videos using the machine learning model to align a resolution of the one or more temporal extension videos with a resolution of media plane 104. For example, experiential media adaptation platform 702 may employ content enhancement engine 730 to align a resolution of one or more input frames with a resolution of media plane 104 (e.g., 16K x 16K) using models 756. Models 756 may implement various techniques to perform the uscaling process, such as super-resolution perceptual image restoration, enhanced super-resolution generative adversarial networks, shifted window transformers, and latent diffusion super-resolution.

In some embodiments, experiential media adaptation platform 702 may employ a tiled-based processing system to upscale one or more input frames. Experiential media adaptation platform 702 may split an input frame into multiple tiles. Experiential media

adaptation platform 702 may then upscale each tile in separate inference processes to align a resolution of each tile with a resolution of media plane 104 (e.g., the total resolution of the venue scaled by the number of tiles). Experiential media adaptation platform 702 may also blend one or more boundary regions between adjacent tiles. In some embodiments, experiential media adaptation platform 702 may employ one or more of models 756 to blend and/or regenerate overlapping regions between tiles. Experiential media adaptation platform 702 may then reassemble the processed tiles into an aggregated high-resolution output. In some embodiments, experiential media adaptation platform 702 may apply additional post-processing and inferences through one or more of models 756 to ensure global spatial consistency (e.g., in color, contrast, sharpness, and across visual artifacts).

At operation 1630, the operational control flow 1600 refines the one or more upscaled frames of the one or more temporal extension videos until a pre-defined temporal coherence threshold is met. For example, experiential media adaptation platform 702 may employ content enhancement engine 730 to refine one or more frames until a pre-defined temporal coherence threshold across a sequence of frames (e.g., one or more frames that have been upscaled) is met. When refining any given frame, content enhancement engine 730 may reference specific features from previous frames to maintain consistent appearance of any subjects, objects, or textures within the sequence. In some embodiments, content enhancement engine 730 may also employ temporal diffusion techniques, which involve calculating a frame difference-based temporal loss between adjacent frames. In such embodiments, content enhancement engine 730 may use the calculated frame difference-based temporal loss to guide the regeneration of the one or more frames. Alternatively or additionally, content enhancement engine 730 may estimate flow maps between adjacent frames and use the estimated flow information to guide the diffusion regeneration process. From this information, content enhancement engine 730 may determine a temporal coherence value and compare the determined value against a pre-defined threshold. In some embodiments, experiential media adaptation platform 702 may also refine the upscaled frames to align with an immersion threshold for a venue.

FIG. 17 illustrates a simplified block diagram of an exemplary computer system that can be implemented within the exemplary experiential media adaptation platform

according to some exemplary embodiments of the present disclosure. The discussion of FIG. 17 to follow is to describe a computer system 1700 that can be used to implement experiential media content workstation 410, experiential media content workstation 612, or experiential media adaptation platform 702 as described above.

In the exemplary embodiment illustrated in FIG. 17, the computer system 1700 includes one or more processors 1702. In some embodiments, the one or more processors 1702 can include, or can be, any of a microprocessor, graphics processing unit, or digital signal processor, and their electronic processing equivalents, such as an Application Specific Integrated Circuit (“ASIC”) or Field Programmable Gate Array (“FPGA”). As used herein, the term “processor” signifies a tangible data and information processing device that physically transforms data and information, typically using a sequence transformation (also referred to as “operations”). Data and information can be physically represented by an electrical, magnetic, optical or acoustical signal that is capable of being stored, accessed, transferred, combined, compared, or otherwise manipulated by the processor. The term “processor” can signify a singular processor and multi-core systems or multi-processor arrays, including graphic processing units, digital signal processors, digital processors or combinations of these elements. The processor can be electronic, for example, comprising digital logic circuitry (for example, binary logic), or analog (for example, an operational amplifier). The processor may also operate to support performance of the relevant operations in a “cloud computing” environment or as a “software as a service” (SaaS). For example, at least some of the operations may be performed by a group of processors available at a distributed or remote system, these processors accessible via a communications network (e.g., the Internet) and via one or more software interfaces (e.g., an application program interface (API).) In some embodiments, the computer system 1700 can include an operating system, such as Microsoft’s Windows, Sun Microsystems’s Solaris, Apple Computer’s MacOs, Linux or UNIX. In some embodiments, the computer system 1700 can also include a Basic Input/Output System (BIOS) and processor firmware. The operating system, BIOS and firmware are used by the one or more processors 1702 to control subsystems and interfaces coupled to the one or more processors 1702. In some embodiments, the one or more processors 1702 can include the Pentium and Itanium from Intel, the Opteron and Athlon from Advanced Micro Devices, and the ARM processor from ARM Holdings.

As illustrated in FIG. 17, the computer system 1700 can include a machine-readable medium 1704. In some embodiments, the machine-readable medium 1704 can further include a main random-access memory (“RAM”) 1706, a read only memory (“ROM”) 1708, and/or a file storage subsystem 1710. The RAM 1730 can store instructions and data during program execution and the ROM 1732 can store fixed instructions. The file storage subsystem 1710 provides persistent storage for program and data files, and may include a hard disk drive, a floppy disk drive and associated removable media, a CD-ROM drive, an optical drive, a flash memory, or removable media cartridges.

The computer system 1700 can further include user interface input devices 1712 and user interface output devices 1714. The user interface input devices 1712 can include an alphanumeric keyboard, a keypad, pointing devices such as a mouse, trackball, touchpad, stylus, or graphics tablet, a scanner, a touchscreen incorporated into the display, audio input devices such as voice recognition systems or microphones, eye-gaze recognition, brainwave pattern recognition, and other types of input devices to provide some examples. The user interface input devices 1712 can be connected by wire or wirelessly to the computer system 1700. Generally, the user interface input devices 1712 are intended to include all possible types of devices and ways to input information into the computer system 1700. The user interface input devices 1712 typically allow a user to identify objects, icons, text and the like that appear on some types of user interface output devices, for example, a display subsystem. The user interface output devices 1714 may include a display subsystem, a printer, a fax machine, or non-visual displays such as audio output devices. The display subsystem may include a cathode ray tube (CRT), a flat-panel device such as a liquid crystal display (LCD), a projection device, or some other device for creating a visible image such as a virtual reality system. The display subsystem may also provide non-visual display such as via audio output or tactile output (e.g., vibrations) devices. Generally, the user interface output devices 1714 are intended to include all possible types of devices and ways to output information from the computer system 1700.

The computer system 1700 can further include a network interface 1716 to provide an interface to outside networks, including an interface to a communication network 1718, and is coupled via the communication network 1718 to corresponding

interface devices in other computer systems or machines. The communication network 1718 may comprise many interconnected computer systems, machines and communication links. These communication links may be wired links, optical links, wireless links, or any other devices for communication of information. The communication network 1718 can be any suitable computer network, for example a wide area network such as the Internet, and/or a local area network such as Ethernet. The communication network 1718 can be wired and/or wireless, and the communication network can use encryption and decryption methods, such as is available with a virtual private network. The communication network uses one or more communications interfaces, which can receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. One or more communications protocols can be used, such as HTTP, TCP/IP, RTP/RTSP, IPX and/or UDP.

As illustrated in FIG. 17, the one or more processors 1702, the machine-readable medium 1704, the user interface input devices 1712, the user interface output devices 1714, and/or the network interface 1716 can be communicatively coupled to one another using a bus subsystem 1720. Although the bus subsystem 1720 is shown schematically as a single bus, alternative embodiments of the bus subsystem may use multiple buses. For example, RAM-based main memory can communicate directly with file storage systems using Direct Memory Access (“DMA”) systems.

### CONCLUSION

The Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to be limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A method for adapting cinematic media to experiential media, the method comprising:
training, by one or more computing devices, one or more machine learning models on a plurality of objects of a cinematic media content;
generating, by the one or more computing devices, using the one or more machine learning models, inferred content of the plurality of objects in a plurality of frames of the cinematic media content to produce a plurality of expanded frames;
temporally extending, by the one or more computing devices, the plurality of expanded frames using the one or more machine learning models to produce a corresponding plurality of temporal extension videos;
aligning, by the one or more computing devices, a plurality of resolutions corresponding to the plurality of temporal extension videos with a resolution of a media plane of a venue; and
composing, by the one or more computing devices, the plurality of temporal extension videos to produce an experiential version of the cinematic media content.

2. The method of claim 1, wherein the training comprises:
performing segmentation on the cinematic media content to obtain a plurality of image segments, wherein each of the plurality of image segments comprises an object from the plurality of objects;
annotating the plurality of image segments with a plurality of descriptive tags; and
fine-tuning the one or more machine learning models with the plurality of annotated image segments.

3. The method of claim 1, further comprising:
training the one or more machine learning models using archival content related to the cinematic media content.

4. The method of claim 1, wherein the aligning the resolution comprises:
applying super-resolution to one or more frames of the temporal extension video using the one or more machine learning models.

5. The method of claim 1, wherein the cinematic media content is in a rectilinear format and the experiential version of the cinematic media content is in a spherical format.

6. The method of claim 1, wherein the one or more machine learning models comprise a diffusion model.

7. The method of claim 1, wherein the one or more machine learning models comprise a diffusion transformer model.

8. The method of claim 1, wherein the plurality of objects comprise a character object and an environment object.

9. An experiential media adaptation server for adapting cinematic media to experiential media, the experiential media adaptation server comprising:
a memory configured to store instructions; and
a processor configured to execute the instructions, the instructions, when executed by the processor, configuring the processor to:
train one or more machine learning models on a plurality of objects of a cinematic media content,
generate using the one or more machine learning models, inferred content of the plurality of objects in a plurality of frames of the cinematic media content to produce a plurality of expanded frames,
temporally extend the plurality of expanded frames using the one or more machine learning models to produce a corresponding plurality of temporal extension videos,
align a plurality of resolutions corresponding to the plurality of temporal extension videos with a resolution of a media plane of a venue, and
compose the plurality of temporal extension videos to produce an experiential version of the cinematic media content.

10. The experiential media adaptation server of claim 9, wherein the instructions, when executed by the processor, configure the processor to:
perform segmentation on the cinematic media content to obtain a plurality of image segments, wherein each of the plurality of image segments comprises an object from the plurality of objects;
annotate the plurality of image segments with a plurality of descriptive tags; and
fine-tune the one or more machine learning models with the plurality of annotated image segments.

11. The experiential media adaptation server of claim 9., wherein the instructions, when executed by the processor, configure the processor to train the one or more machine learning models using archival content related to the cinematic media content.

12. The experiential media adaptation server of claim 9, wherein the instructions, when executed by the processor, configure the processor to apply super-resolution to one or more frames of the temporal extension video using the one or more machine learning models.

13. The experiential media adaptation server of claim 9, wherein the cinematic media content is in a rectilinear format and the experiential version of the cinematic media content is in a spherical format.

14. The experiential media adaptation server of claim 9, wherein the one or more machine learning models comprise a diffusion model.

15. The experiential media adaptation server of claim 9, wherein the one or more machine learning models comprise a diffusion transformer model.

16. A venue for providing experiential media, the venue comprising:
a media plane configured to present an experiential version of a cinematic media content to an audience within the venue; and
an experiential media adaptation server configured to:
train one or more machine learning models on a plurality of objects of the cinematic media content,
generate using the one or more machine learning models, inferred content of the plurality of objects in a plurality of frames of the cinematic media content to produce a plurality of expanded frames,
temporally extend the plurality of expanded frames using the one or more machine learning models to produce a corresponding plurality of temporal extension videos,
align a plurality of resolutions corresponding to the plurality of temporal extension videos with a resolution of the media plane, and
compose the plurality of temporal extension videos to produce the experiential version of the cinematic media content.

17. The venue of claim 16, wherein the experiential media adaptation server is further configured to:
perform segmentation on the cinematic media content to obtain a plurality of image segments, wherein each of the plurality of image segments comprises an object from the plurality of objects;
annotate the plurality of image segments with a plurality of descriptive tags; and
fine-tune the one or more machine learning models with the plurality of annotated image segments.

18. The venue of claim 16, wherein the experiential media adaptation server is further configured to train the one or more machine learning models using archival content related to the cinematic media content.

19. The venue of claim 16, wherein the experiential media adaptation server is further configured to apply super-resolution to one or more frames of the temporal extension video using the one or more machine learning models.

20. The venue of claim 16, wherein the cinematic media content is in a rectilinear format and the experiential version of the cinematic media content is in a spherical format.
